(19) United States
(12) Patent Application Publication
(10) Pub. No.: US 2010/0144269 A1
(43) Pub. Date: Jun. 10, 2010

(54) LOW-ENERGY DETECTION OF A TRANSPONDER BY MEANS OF READ UNIT AND A SYSTEM FOR IDENTITY DETERMINATION AND/OR AUTHORIZATION DETERMINATION, OPTIONALLY IN THE FORM OF A LOCKING SYSTEM

(75) Inventors: Tien-Toan Do, Munchen (DE); Ludger Voss, Munchen (DE)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Smonsvoss Technologies AG, Unterfohring (DE)

(21) Appl. No.: 12/531,923

(22) PCT Filed: Mar. 14, 2008
(86) PCT No.: PCT/EP2008/002064

§ 371 Date: Feb. 26, 2010

(30) Foreign Application Priority Data
Mar. 19, 2007 (EP) 07005627.0

(51) Int. Cl. H04B 5/00; G08B 13/14

(52) U.S. Cl. 455/41.1; 340/572.1

(57) ABSTRACT

Among others, the invention relates to a method and a system for controlling a system for receiving a wireless data transmission between at least two components (12, 100, 50), wherein at least one wireless interface (102, 112) can be activated, or is activated, for wireless data transmission. According to the invention, a first component (100) monitors an environment for the occurrence of at least one predefined change and/or for the occurrence of at least one predefined feedback from the environment. Once such a change, or feedback, has occurred, a wireless interface (102) is activated for the wireless data transmission, and optionally for the energy supply of a second component (50) via the wireless interface. The predefined change or feedback is caused particularly in that the second component (50) is returned to the environment. The system may be a system (10) for determining the identity and/or authorization, such as a locking system. The first component (100) may arrange an interaction between the second component (50) and a further component (12), which, for example, is associated with a target mechanism.

### FIELD OF THE INVENTION

According to a first aspect, the invention relates to a read unit such as an RFID or NFC read unit which comprises: at least one wireless interface configured to generate, in at least one coupling operating state of the read unit, at least one of an electrical alternating field and a magnetic alternating field and an electromagnetic radiation alternating field in order to be able to couple, inductively and/or capacitively and/or electromagnetically to a transponder located in an allocation region, optionally an RFID or NFC transponder; a control device which is configured or programmed to respond, in the coupling operating state by means of the wireless interface, to a coupled transponder to carry out data communication comprising at least one of the following: a read-out of at least one data value from the transponder and a receipt of at least one data value transmitted from the transponder and a transmission of at least one data value to the transponder, and/or at least in the sense of a detection of the presence of the coupled transponder; and an electrical energy supply supplying the control device and the wireless interface with electrical operating energy.

### BACKGROUND OF THE INVENTION

Conventional read units of the above-mentioned type, for instance Radio Frequency Identification (RFID) readers or card readers establish a permanent electromagnetic near-field at a frequency of 125 kHz or 13.56 MHz, for example. Passive transponders, for example a transponder designed as an RFID card, that are brought into this near field obtain energy from this field and use the energy thus acquired to establish communication with the reader, in order to swap identification data for example. This read unit identifies the presence of a transponder through the energy loss of the electromagnetic near-field which it detects as a load. Data transfer from the transponder to the read unit often takes place using so-called load modulation whereby the transponder modulates the energy loss and the read unit detects this as the modulation of the load. Reference is made to the relevant technical literature for RFID technology and for Near Field Communication (NFC) technology as well as the pertinent standards. The reference book entitled “RFID-Handbuch—Grundlagen und praktische Anwendungen induktiver Funkanlagen, Transponder und kontaktloser Chipkarten” [RFID Handbook—Fundamentals and practical applications of inductive radio transponders and contactless chip cards] by Klaus Finkenzeller, 4^{th} Edition, Karl Hanser Verlag Munich—Vienna, 2006 provides a good overview of RFID technology.

The near field which manifests itself chiefly as an electrical alternating field or a magnetic alternating field or an electromagnetic radiation alternating field is permanently maintained so that the read unit can respond immediately when a transponder is introduced into the near-field region and the read unit does not first have to be switched on by a user for instance. Permanently maintaining this near field does, however, require a relatively large amount of energy and conventional read units are therefore externally supplied with energy and this entails considerable installation costs.

### SUMMARY OF THE INVENTION

In contrast, the object of the invention is to significantly reduce the energy consumption of such a read unit, at least at times when there is no data exchange between the read unit and a transponder, especially in order to make it possible to use a battery or rechargeable-battery based energy supply without any cable-based supply of electrical energy while still allowing a relatively long battery or rechargeable battery life.

In order to achieve this object it is proposed in relation to the above-mentioned read unit, according to a first aspect of the invention, that at least the wireless interface is switched off in at least an idle operating state of the read unit so that the electrical energy consumption of the wireless interface is at least reduced; that the wireless interface is switched on in the coupling operating state of the read unit so that a transponder located in the allocation region can couple inductively or capacitively or electromagnetically to the wireless interface; and that the control device is configured or programmed to automatically switch between several operating states including the idle operating state and the coupling operating state.

Because the wireless interface is switched off in the idle operating state, the wireless interface consumes no electrical energy or only consumes electrical energy to a reduced extent. Almost all the components of the read unit can optionally be switched off in the idle operating state with the exception of a device which automatically switches back from the idle operating state. For example, an appropriate watchdog timer or the like can be provided which, at specific time intervals, ensures that the read unit switches back from the idle operating state to the coupling operating state or a monitoring operating state. By switching between operating states of the read unit, the read unit can still respond to introduced transponders, supply them with energy in the case of passive transponders and read out data from them or swap data with them. The energy consumption of the read unit is primarily and decisively determined by the energy consumption in the coupling operating state of the read unit so that the electrical energy requirement is therefore significantly reduced simply by the fact that the read unit only switches to the coupling operating state at time intervals or periodically. Especially large energy savings can be made if the read unit only switches to the coupling operating state when a transponder is actually pretransmitted in the allocation region or its vicinity.

In this connection, there are two feasible possibilities in particular, namely that the control device is configured or programmed to automatically switch from the idle operating state directly into the coupling operating state or from the idle operating state via a separate monitoring operating state of the read unit into the coupling operating state of the read unit. In addition, it is feasible that the control device is configured or programmed to automatically switch from the coupling operating state into the idle operating state.

According to a first approach for transponder detection, it is proposed that the control device is configured to repeatedly switch at time intervals from the idle operating state into the coupling operating state or special monitoring coupling operating state in order to check, by means of the or a wireless interface, whether a transponder is pretransmitted in the allocation region. It is possible, for instance, to reduce the current consumption of the read unit by using a type of polling method whereby the read unit is in the “idle operating state” at certain times, preferably most of the time, i.e. in a kind of “sleep mode” in which current consumption is low but where the read unit, at time intervals, repeatedly or periodically (e.g. once a second) changes to the coupling operating state, i.e. is “woken up”, in order to determine whether a transponder is located in the allocation region or the near field of the wireless interface. To achieve this, the alternating field of the wireless interface must be fully or almost fully established in order to make it possible to then check whether a transponder is pretransmitted in the alternating field by detecting field attenuation for instance. If no transponder is detected, the read unit automatically switches back to the idle operating state.

It is proposed, especially in this connection, that a monitoring device allocated or associated with the control device and, if desired, with its own monitoring interface is configured, in the monitoring coupling state, to respond to an energy loss of the alternating field or a monitoring alternating field produced by the monitoring wireless interface by the coupled transponder in order to determine the presence of a transponder in the allocation region or in the surrounding region into which the monitoring alternating field extends. A monitoring device which has its own monitoring wireless interface is advantageous in that it saves a certain amount of energy compared with the possibility of implementing monitoring based on the wireless interface which is also used for data communication because the components that are only used for data communication and other processing can remain switched off.

As an enhancement of the invention, it is proposed that at least one field generation arrangement, optionally antenna arrangement, is provided which is allocated or can be allocated, as a monitoring field generation arrangement, optionally monitoring antenna arrangement, to the monitoring device to produce the monitoring alternating field. As explained below, the monitoring wireless interface can use the same field generation arrangement as that of the wireless interface which is used for data communication. From a functional viewpoint, it nevertheless makes sense in such a case to regard the monitoring wireless interface as a separate, dedicated wireless interface of the monitoring device compared with the wireless interface which is used for data communication.

Using the polling technique to detect a transponder in the allocation region makes it possible to reduce the consumption of electrical energy quite considerably, for example by 2 to 3 orders of magnitude, compared with the average current consumption of a conventional, unpolled RFID read unit. Battery-based energy supply is completely feasible for a read unit of such design; from a practical viewpoint this will involve battery replacement at specific intervals, for instance annually, which will be relatively unacceptable for many applications.

In contrast, it is preferable that the read unit has a monitoring device which is preferably independent of the wireless interface and is allocated or associated with the control device with the monitoring device being configured to respond to at least one change in the surrounding region of the read unit or at least one feedback from the surrounding region and the control device being configured or programmed to react to the monitoring device responding to the change or feedback by switching into the coupling operating state in order to check, by means of the or a wireless interface, whether a transponder is pretransmitted in the allocation region and/or to start data communication by means of the wireless interface. In this respect, the primary consideration is that the monitoring device allows monitoring of the surrounding region with electrical energy consumption that is considerably less than that of the wireless interface in the coupling operating state. If this is the case, the monitoring device makes it possible to reduce the time-averaged consumption of electrical energy because it is only necessary to switch to the coupling operating state when the monitoring device has responded to a change in the monitoring region or feedback from the surrounding region which might be caused by the introducing an allocated transponder into the allocation region, so that is only necessary to switch to the coupling operating state in order to check whether a transponder is actually pretransmitted in the allocation region or in order to start data communication with the transponder immediately or after such a checking process.

It is possible to envisage the monitoring device being active in the idle operating state or it being possible to repeatedly activate it at time intervals in the idle operating state in order to monitor the surrounding region for the occurrence of at least one change or feedback. In principle, it is therefore also feasible for the monitoring device to be continuously active in order to monitor the surrounding region. This is, however, not necessary as a rule and a polling mode is considered for the monitoring device in order to keep the time-averaged electrical energy consumption of the monitoring device accordingly low as possible.

One especially preferred embodiment is characterised by the fact that in a/the monitoring operating state of the read unit a) the monitoring device is active or can be repeatedly activated at time intervals, in order to be able to respond to the occurrence of at least one change in the surrounding region or the occurrence of a least one feedback from the surrounding region, and b) the wireless interface or at least a component of the wireless interface consuming electrical energy is switched off, so that the electrical energy consumption of the wireless interface is at least reduced; the control device being configured or programmed to automatically switch from the monitoring operating state into the coupling operating state when the monitoring device responds to a change in the surrounding region or to feedback from the surrounding region.

In principle, there are many possibilities as far as the design and operating principle of the monitoring device are concerned. It is feasible to envisage the monitoring device radiating acoustic or electromagnetic waves and responding to reflected waves or the monitoring device responding to infrared radiation. In this respect, the reader is referred to corresponding solutions for room surveillance or automatically switching on lighting as potential implementations. In contrast, it is preferable, however, that the monitoring device is configured to respond to a change in at least one electrical and/or magnetic property and/or least one electromagnetic property of the surrounding region. In this case this means, above all, defined changes in the electrical or magnetic properties of the surrounding area which can be triggered by introducing a transponder into the surrounding area which, depending on the transponder type, will have, as a rule, defined electrical or magnetic characteristics, thus, by taking into account potential transponders, enabling the monitoring device to respond selectively, at least in relation to specific types of transponders which are preferably to be used.

As an especially expedient solution, it is proposed that the monitoring device is configured to respond to an oscillating circuit located in the surrounding region and/or to an inductor located in the surrounding region, which interacts with an oscillating circuit and/or an inductor of the monitoring circuit on the basis of an electrical and/or magnetic alternating field or on the basis of an electromagnetic alternating field. This way, it is possible to achieve an especially highly selective response by the monitoring device, it being technically simple to detect the feedback resulting from this interaction.

As an enhancement of the invention, it is proposed that the monitoring device is configured to generate at least one of: an electrical sensor alternating field extending into the monitoring region and a magnetic sensor alternating field and an electromagnetic sensor alternating sensor field, and to detect at least one sensor variable which, on the basis of the sensor alternating field, depends on the electrical or magnetic or electromagnetic property of the surrounding area and/or, on the basis of the sensor alternating field, depends on magnetic and/or electrical and/or electromagnetic feedback from the surrounding area. The feedback referred to is feedback of the oscillating circuit or the inductor in the surrounding region to the oscillating circuit or inductor of an oscillating circuit of the monitoring device.

A monitoring device with such a design can be produced inexpensively using easily available components. This also has the advantage that components of the wireless interface can, if desired, fulfil a dual function namely and firstly acting as part of or an allocated component of the wireless interface in the coupling operating state and, secondly, acting as part of or an allocated component of the monitoring device in the idle operating state or monitoring operating state. An antenna arrangement and/or an oscillating circuit for example arrangement can fulfil such a dual function. Even though the antenna arrangement or, generally speaking, a field generation arrangement is associated with the wireless interface in the coupling operating state on the one hand and associated with the monitoring device in the idle operating state or monitoring operating state on the other hand, from a functional viewpoint it makes sense to regard the monitoring device as independent of the wireless interface.

The above explanations show that the electrical energy consumption attributable to generating the sensor alternating field is reduced compared with the electrical energy consumption attributable to generating the alternating field produced by the wireless interface in the coupling operating state. In this respect, it is intended that the field strength of the sensor alternating field and/or the power radiated thereby is reduced compared with the field strength of the alternating field generated by the wireless interface or the power radiated thereby in the coupling operating state. In relation to the passive transponders mentioned above, in this respect it is intended that the alternating field generated by the wireless interface in the coupling operating state is suitable for supplying an allocated passive transponder in the allocation region with sufficient electrical energy to operate the passive transponder whereas, the sensor alternating field is not suitable for supplying such a passive transponder in the allocation area with sufficient electrical energy to operate the passive transponder.

The term “sensor alternating field” does not necessarily imply a specific generation method or a specific characteristic of the alternating field generated by the monitoring device and the term primarily denotes the function of this alternating field, namely that it fulfils a kind of sensor function; expedient differences between the sensor alternating field and the alternating field of the wireless interface in terms of energy consumption etc. have already been mentioned above.

According to one preferred embodiment, the monitoring device has an oscillator which can be excited to a free electrical oscillation on which the generation of the sensor alternating field is based, in such a way that an instantaneous oscillation frequency depends on the electrical or magnetic or electromagnetic property of the surrounding region or on the feedback from the surrounding region, the instantaneous oscillation frequency or a detection variable reflecting this or a dependent variable depending on the oscillation frequency or detection variable being detectable as a sensor variable.

As an enhancement of the invention, it is proposed that the monitoring device is configured or programmed to compare a respectively detected sensor variable or variables with at least one predetermined reference variable or at least a reference variable that can be predetermined from at least one previously detected sensor variable on the basis of at least one predetermined monitoring condition, and to respond or not respond to a change in the surrounding region or feedback from the surrounding region as a function of the fulfillment or non-fulfillment of the monitoring condition. This way it is possible to obtain good monitoring-device selectivity with regard to detecting the introduction of a transponder into the surrounding region.

Provision can advantageously be made for it to be possible to switch the read unit into a calibration operating state, preferably an auto calibration operating state which is repeatedly assumed automatically at time intervals, in which, on the basis of at least one sensor variable detected by the monitoring device, preferably an average sensor variable detected over a calibration time period, a plurality or at least one variable quantity which is decisive for subsequent monitoring operation of the monitoring device is determined and set as a predetermined reference variable. At least one basic calibration operation after positioning the read unit in a specific location is advantageous so that the electrical or magnetic properties of the environment of the read unit can be taken into account. Thus, the prevailing oscillation frequency will depend, for instance, on the material from which the fixture or holder which contains or holds the read unit is made and on materials that are pretransmitted in the immediate vicinity. Calibration repeated at time intervals or periodically could take into account changes in the oscillation frequency as a result of variations in temperature or changes in the environment. It may optionally be possible to calibrate the actual monitoring conditions themselves. It is then possible to reliably detect changes in the oscillation frequency as a result of introducing a transponder into the surrounding region on the basis of such calibrations as stated above.

Basically, there are many possible ways of detecting a sensor variable. According to one preferred embodiment, provision is made for the monitoring device to have a counter responding to the electrical oscillation, instantaneous counter readings or dependent variables determined therefrom or variables determined on the basis of reaching a respective trigger counter reading being detectable as sensor variables. This makes it possible to realise the monitoring device very inexpensively.

The above explanations and the meaning and purpose of the monitoring device as a component of the read unit show that the monitoring conditions and the sensor alternating field are preferably selected or set or adjustable so that introducing a transponder into the allocation region causes a change in the electrical or magnetic or electromagnetic property of the surrounding region or feedback from the surrounding region which results in the monitoring device responding so that the control device consequently reacts by switching over to the coupling operating state.

The read unit can expediently have at least one field generation arrangement, optionally antenna arrangement, which is allocated or can be allocated as a monitoring field generation arrangement, optionally monitoring antenna arrangement, to the monitoring device to generate the sensor alternating field. As an enhancement of the invention, it is proposed that the monitoring field generation arrangement allocated to the monitoring device is used as a frequency-determining or frequency-influencing component of the oscillator. Furthermore, it is proposed that the oscillator comprises an amplifier assembly, the output of which is linked back or can be looped back via the monitoring field generation arrangement for the purpose of positive feedback to an input of the amplifier assembly.

In one especially expedient embodiment, the amplifier assembly, together with the monitoring field generation arrangement, forms a capacitive or inductive three-point oscillator circuit, preferably a Collpits oscillator circuit. Such an oscillator is affordable to manufacture and operates very reliably.

It can be possible to operate the field generation arrangement, optionally antenna arrangement, as a wireless-interface field generation arrangement, optionally wireless-interface antenna arrangement, in the coupling operating state of the wireless interface. Compared with the wireless interface, the monitoring device therefore does not necessarily need its own field generation arrangement, as already stated.

As an enhancement of the invention and to ensure reliable operation both of the monitoring device and the wireless interface, it is proposed to provide an isolation arrangement by means of which, for operation as a monitoring field generation arrangement, the field generation arrangement can be electrically isolated from a driver circuit of the wireless interface in respect of alternating signals and/or in respect of DC signals and by means of which, for operation as a wireless-interface field generation arrangement, the field generation arrangement can be electrically isolated from at least one other component of the monitoring circuit in respect of alternating signals and/or in respect of DC signals. The isolation arrangement can comprise a switch arrangement and/or a diode arrangement and/or a capacitor arrangement with the switch arrangement preferably being designed as a semiconductor switch arrangement.

The surrounding region can encompass the allocation region and therefore be as large or larger than the allocation region. Alternatively, the allocation region can encompass the surrounding region and therefore be larger or the same size as the latter. As a rule, however, the surrounding area is completely contained in the allocation region or the allocation region is completely contained in the surrounding region.

As far as the allocation region is concerned, it is primarily intended that this is a near zone such that a transponder which is located in the near zone, optionally a short-range transponder, can couple inductively or capacitively to the wireless interface on the basis of near-field coupling.

The near-field read unit can be provided for use with low-frequency (LF) transponders and the alternating field or monitoring alternating field or sensor alternating field can be a low-frequency alternating field. Furthermore, the near-field read unit can be provided for use with high-frequency/radio-frequency (HF/RF) transponders and the alternating field or monitoring alternating field or sensor alternating field can be a high-frequency/radio-frequency alternating field.

As a rule, the read unit or short-range read unit is designed as a transmitter-receiver unit or transceiver which can therefore not only read out data from the transponder but can also receive data transmitted by the transponder and transmit data to the transponder. The coupling operating state may comprise a detection mode and a data transfer mode wherein a coupled transponder in the allocation area can be detected in the detection mode and at least one data value can be read out from the detected transponder in the data transfer mode or can be received from the transponder and/or at least one data value can be transmitted to the detected transponder.

As a rule, the wireless interface of the read unit is configured to transmit data signals to a coupled transponder and/or to receive data signals from a coupled transponder. In this respect, the primary intention is that the control device of the read unit is configured or programmed for at least unidirectional, but preferably bidirectional, data communication with a coupled transponder via the wireless interface.

According to the invention and suggested enhancements, it is quite possible for the electrical energy supply of the read unit to be a rechargeable-battery or battery energy supply without this causing practical problems of any kind whatsoever.

The primary, but not exclusive, intention is that the read unit can be operated as a reader in accordance with a Radio Frequency Identification (RFID) standard or that the read unit can be operated optionally as a reader or transponder in accordance with a Radio Frequency Identification (RFID) or Near Field Communication (NFC) standard. Communication between NFC devices can take place, as in the case of conventional RFID devices, between an active and a passive device, but also between an active device and another active device in the sense of peer-to-peer communication, which has considerable resulting application-specific advantages.

According to a second aspect, the invention relates to a monitoring device for monitoring a surrounding region for changes and a monitoring method for monitoring a surrounding region for changes. Such devices and methods are known, for instance proximity switches and lighting which switches on automatically etc., some of them being based on emitting ultrasonic or electromagnetic radiation, for example radio waves, and also, sometimes, additionally or alternatively, on detecting infrared radiation.

In contrast and according to the second aspect of the invention, it is proposed that the monitoring device is configured to generate at least one of an electrical sensor alternating field extending into the monitoring region and a magnetic sensor alternating field and an electromagnetic sensor alternating sensor field, and to detect at least one sensor variable which, on the basis of the sensor alternating field, depends on an electrical and/or magnetic property and/or an electromagnetic property of the surrounding region and/or, on the basis of the sensor alternating field, depends on feedback from the surrounding region, and to compare it with at least one predetermined or predeterminable reference variable on the basis of least one predetermined monitoring condition. Advantageously, the monitoring device can have an oscillator which can be excited to a free electrical oscillation on which the generation of the sensor alternating field is based, in such a way that an instantaneous oscillation frequency depends on the electrical or magnetic or electromagnetic property of the surrounding region or on the feedback from the surrounding region, the instantaneous oscillation frequency or a detection variable reflecting this or a dependent variable depending on the oscillation frequency or detection variable being detectable as a sensor variable.

The monitoring device can advantageously be configured to respond to an oscillating circuit located in the surrounding region and/or to an inductor located in the surrounding region, which interacts on the basis of the sensor alternating field with an oscillating circuit belonging to the oscillator and/or an inductor belonging to the oscillator and thus feeds back to the oscillation frequency.

For the monitoring method and according to the second aspect of the invention, it is accordingly proposed that at least one of an electrical sensor alternating field extending into the monitoring region and a magnetic sensor alternating field and an electromagnetic sensor alternating sensor field is generated and, on the basis of the sensor alternating field, at least one sensor variable depending on an electrical and/or magnetic property and/or an electromagnetic property of the surrounding region and/or, on the basis of the sensor alternating field, depending on feedback from the surrounding region, is detected and compared with at least one predetermined or predeterminable reference variable on the basis of least one predetermined monitoring condition. Advantageously, an oscillator can be excited to a free electrical oscillation on which the generation of the sensor alternating field is based, in such a way that an instantaneous oscillation frequency depends on the electrical or magnetic or electromagnetic property of the surrounding region or on the feedback from the surrounding region, the instantaneous oscillation frequency or a detection variable reflecting this or a dependent variable depending on the oscillation frequency or detection variable being detectable as a sensor variable.

The method can be characterised by a response to an oscillating circuit located in the surrounding region and/or to an inductor located in the surrounding region, which interacts on the basis of the sensor alternating field with an oscillating circuit belonging to the oscillator and/or an inductor belonging to the oscillator and thus feeds back to the oscillation frequency.

The monitoring device can be part of a read unit according to the first aspect of the invention or be intended for such a read unit. The monitoring method can be part of an operating method of a read unit in accordance with the first aspect of the invention. The above explanations regarding the read unit in accordance with the first aspect of the invention and its enhancement with a monitoring device result in further advantageous features of the monitoring device and of the monitoring method in accordance with the second aspect of the invention.

According to a third aspect, the invention relates to a method for controlling a system when receiving a wireless data transmission between a first component and a second portable component wherein the method comprises the activation of least one wireless interface for wireless data communication. Such methods are disclosed, for example, in EP 0 744 843 B1, DE 195 19 450 A1 and EP 1 585 268 A2. Known methods are based on one of the components transmitting an activation signal to the other component, it thus only being possible to use the method expediently in specific system interrelationships.

According to a third aspect, the invention aims to specify an appropriate method which works without an activation signal so that the second portable component can be designed as a passive component, for instance, with it nevertheless being possible to activate a wireless interface of the first unit without it having to be constantly active.

In order to achieve this object and in accordance with the third aspect of the invention, it is proposed that the first component repeatedly monitors a surrounding region, continuously or—preferably—at time intervals, for the occurrence of at least one predefined change and/or the occurrence of at least one predefined feedback from the surrounding region, and then, if a change or feedback of this type occurs, activates the wireless interface for the wireless data transmission and optionally for the energy supply of the second component via the wireless interface, the predefined change or feedback being caused by the fact that the second component is brought into the surrounding region. The first component can, for example, be a read unit in accordance with the first aspect of the invention. The second portable component can, for example, be a transponder, for instance an RFID or NFC transponder.

As an enhancement of the invention, it is proposed that the first component monitors the surrounding region for the occurrence of a change in at least one electrical or magnetic or electromagnetic property of the surrounding region. In this respect, as an especially preferred solution, it is proposed that the first component responds to an oscillating circuit located in the surrounding region and/or to an inductor located in the surrounding region, which interacts on the basis of an electrical and/or magnetic alternating field or electromagnetic alternating field with an oscillating circuit and/or an inductor of the first component. In one preferred embodiment, the first component monitors the surrounding region in accordance with the monitoring method in accordance with the second aspect of the invention. To achieve this, the first component can be designed as a monitoring device in accordance with the second aspect of the invention or can have such a monitoring device.

Preferably, it is proposed that the first component generates at least one of an electrical sensor alternating field extending into the monitoring region and a magnetic sensor alternating field and an electromagnetic sensor alternating sensor field, and detects at least one sensor variable which, on the basis of the sensor alternating field, depends on an electrical and/or magnetic property and/or an electromagnetic property of the surrounding region and/or, on the basis of the sensor alternating field, depends on feedback from the surrounding region, and compares it with at least one predetermined or predeterminable reference variable on the basis of least one predetermined monitoring condition. To achieve this, an oscillator of the first component can be excited to a free electrical oscillation on which the generation of the sensor alternating field is based, in such a way that an instantaneous oscillation frequency depends on the electrical or magnetic or electromagnetic property of the surrounding region or on the feedback from the surrounding region, the instantaneous oscillation frequency or a detection variable reflecting this or a dependent variable depending on the oscillation frequency or detection variable being detected as a sensor variable. It is thus possible to ensure, in particular, that the first component responds to an oscillating circuit located in the surrounding region and/or to an inductor located in the surrounding region, which interacts on the basis of the sensor alternating field with an oscillating circuit belonging to the oscillator and/or an inductor belonging to the oscillator and thus feeds back to the oscillation frequency.

According to a fourth aspect, the invention relates to a system for determining identity and/or determining authorisation and, optionally, enabling or preventing logical and/or physical access to a target mechanism, comprising: a first unit which is optionally allocated to the target mechanism and which has a determining means which is configured to determine an identity and/or an authorisation on the basis of a preferably encrypted and/or bidirectional data exchange via a first wireless interface of the first unit with a second unit, the first wireless interface being configured for wireless data exchange over a first range; and at least one second unit, which has a notification means and is allocated to the first unit, is configured to notify the determining means of the first unit of an identity and/or authorisation on the basis of existing identification data and/or authorisation data and the data exchange performed via the first wireless interface and a second wireless interface of the second unit over the first range.

There are various known means and methods for identifying persons and allowing or preventing logical and/or physical access to a target mechanism which operate, for example, on the basis of portable and stationary identification units or identification credentials (credentials for short), for instance in the form of keys, chip cards and transponders. The reader is referred to the applicant's patents DE 103 41 370 A1, WO 2005/027055 A1, EP 1 253 559 A2 and DE 20 2006 006 859 U1 and to the prior art described therein. In this respect, EP 0 744 843 B1, EP 1 643 457 A1, DE 102 40 396 A1 and DE 203 06 923 U1 and the prior art described therein are also of general interest. The disclosure of the Applicant's above-mentioned publications is incorporated into the disclosure of the pretransmitted application by reference.

Such identification systems and methods have become familiar in connection with electronic or digital lock cylinders (electronic cylinders) in particular, in which a respective digital lock cylinder can be unlocked wirelessly by means of a transponder or optionally a transponder which has a biometric sensor, for instance a fingerprint sensor, in order to open a door. The reader's attention is drawn to the applicant's Transponder 3064, Biometric Transponder Q3007, Digital Lock Cylinder 3061 and, generally speaking, the 3060 Locking and Organisational System. Furthermore, the reader's attention is also drawn to the 3068 PIN Keypad associated with this system; this keypad can be used as a permanently installed unit as an alternative to a transponder and be used to unlock a respective digital lock cylinder wirelessly in order to open a door by entering a PIN which specifies an access authorisation. The applicant's system also includes a relay unit called Smart Relay 3063 which can be used to control other machines or installations by using a transponder or a PIN keypad.

The wireless interfaces of the above-mentioned components of the applicant's system operate in a low-frequency range over a comparatively short range in order to be able to selectively unlock a digital lock cylinder to open a door or selectively control specific equipment or installations and reliably prevent operator error by inadvertently activating more distant lock cylinders or installations. To this extent, the system is based on the concept of allowing a door to be opened or any equipment or device to be activated by relying, to a certain extent, on a “proximity effect” for the wireless interface between the identification unit (transponder or PIN keypad) and between the digital lock cylinder or relay unit in order to be able to selectively open various doors or selectively activate various devices by using a portable identification unit without first having to enter a code or the like which identifies the specific door or specific equipment or specific installation.

In relation to the above-mentioned system for determining identity or determining authorisation and, optionally, allowing or preventing logical or physical access to a target mechanism, in the case of the applicant's known system, the digital lock cylinder or smart relay is referred to as the first unit and the various transponders and PIN keypad are referred to as the second unit.

Consideration has already been given to providing credentials, for instance so-called smart cards, which are intended as a company ID or the like with a key function because large companies, for example, are now moving towards accommodating a visual identification function (by means of a photo on the company ID) and an electronic identification function on one and the same credential. The unification of company ID management and key management offers obvious scope for potential savings. One approach to solving the problem of providing smart cards or other credentials which are used as a company IDs with a key function for electronic locking systems, especially electronic or digital lock cylinders, is described in EP 1 253 559 A2. This Offenlegungsschrift proposes an identification card holder for combining a company ID and a key function which has an identification-card reader device as well as a control device and a short-range wireless interface for communicating with an electronic cylinder of a locking system. The identification card holder makes it possible for the locking system to use an identification card which is, in itself, intended for other purposes rather than an active or passive transponder, such as one according to DE 106 14 215, which has a short-range wireless interface specially related to the electronic cylinder, without having to issue new identification cards with such a short-range wireless interface. In relation to the above-mentioned system for secure personalised identification and, optionally, allowing or preventing logical and/or physical access to a target mechanism, the identification card holder, together with a respective company ID, can be referred to as the second unit of the system.

In contrast, the invention aims to provide a system of the above-mentioned kind in accordance with the fourth aspect in which it is completely possible to make various identification credentials, typically credentials allocated to various persons and which are suitable per se for wireless data exchange but which cannot themselves connect to the first unit wirelessly, serviceable for personalised identification or determining authorisation with respect to the first unit.

To achieve this object, the invention provides, according to the fourth aspect, a system for determining identity and/or determining authorisation and, optionally, for allowing or preventing logical and/or physical access to a target mechanism, comprising: a first unit, which is optionally allocated to the target mechanism and has a determining means which is configured to determine an identity and/or an authorisation on the basis of preferably encrypted and/or bidirectional data exchange via a first wireless interface of the first unit with a second unit, the first wireless interface being designed for wireless data exchange over a first range; and at least one second unit which is allocated to the first unit and has a notification means which is configured to notify the determining means of an identity and/or an authorisation on the basis of existing identification data and/or authorisation data and the data exchange performed via the first wireless interface and a second wireless interface of the second unit over the first range, the system having also according to the invention at least one portable identification credential which carries at least identification data and has an identification-credential wireless interface which is designed to wirelessly read out or transmit over a second range at least the identification data or identification data and/or authorisation data provided on the basis of these identification data by a determining means of the identification credential if an identity and/or authorisation is positively determined; the notification means further being configured to receive the identification data and/or authorisation data from the identification credential or read out said data therefrom via a third wireless interface of the second unit and the identification-credential wireless interface over the second range and to use these data or identification data or authorisation data, provided on the basis of these data by a determining function of the notification means of the second unit if an identity and/or authorisation is positively determined, as the available identification data or authorisation data for notifying the determining means of the first unit of an identity or authorisation.

To achieve this object, according to the fourth aspect the invention provides a system for identity determination or/and authorisation determination, and if appropriate for enabling or preventing a logical or/and physical access to a destination device, comprising: a first unit, which may be associated with the destination device, and which has a determination device which is designed to determine, on the basis of a preferably encrypted or/and bidirectional data exchange via a first wireless interface of the first unit with a second unit, an identity or/and an authorisation, the first wireless interface being designed for wireless data exchange over a first range; and at least one second unit which is associated with the first unit, and has a notification device, which is designed to notify to the determination device of the first unit an identity or/and an authorisation, on the basis of existing identification data or/and authorisation data and of the data exchange which is carried out via the first wireless interface and a second wireless interface of the second unit over the first range, the system according to the invention having additionally at least one portable ident medium, which carries at least identification data and has an ident medium wireless interface, which is designed for wireless readout or transmission over a second range at least of the identification data or of identification data or/and authorisation data which is supplied on the basis of this identification data by a determination device of the ident medium in the case of a positive determination of an identity or/and authorisation; the notification device of the second unit also being designed to receive at least the identification data or/and authorisation data of the ident medium via a third wireless interface of the second unit and the ident medium wireless interface over the second range, or to read it out from it, and to use this data or identification data or/and authorisation data which is supplied on the basis of this data by a determination function of the notification device of the second unit in the case of a positive determination of an identity or/and authorisation as existing identification data or authorisation data for notification of an identity or authorisation to the determination device of the first unit.

Thus according to the invention it is not the second unit or the combination of an ident medium and a holder mechanically connected to it which is used as the ident medium, but the second unit is, relative to the portable ident medium, a separate unit which can be placed independently of it, preferably stationary in association with the first unit, and which is wirelessly connected to the portable ident medium, to make identity determination or authorisation determination possible on the basis of at least the identification data carried by the ident medium by carrying out wireless data communication between the first and the second unit and the second unit and the ident medium.

The inventive proposal is specially, but not exclusively, directed at making smart cards, transponders and similar, in particular RFID or NFC transponders, which have wireless interfaces, suitable for personalised identification or personalised proof of authorisation to the first unit, e.g. a locking system or a digital lock cylinder, as already discussed. For this purpose, in principle it is sufficient if by means of the second unit, identification data carried by the ident medium is notified to the first unit, all this data being read out and transmitted wirelessly. However, for higher security it is preferred that the identity determining device is an authentification device, and is designed to authentificate a notified identity or authorisation, on the basis of authentication data which is supplied wirelessly from an authentication device. The term “authentification” here means the process of checking (verifying) the claimed identity or authorisation of a counter-party (e.g. a person carrying the portable ident medium or the ident medium itself) in a dialogue, whereas the term “authentication” means the process of proving one's own identity or authorisation. These two expressions are often used synonymously. Relevant authentication methods are based on use of a possession (the subject who claims an identity possesses something, e.g. a key), disclosure of knowledge (the subject knows something, e.g. a password) and the presence of the subject himself or herself (the subject is something, e.g. use of a biometric feature). All these approaches come into consideration with the inventive proposal, according to the fourth aspect.

It absolutely comes into consideration that on the first unit side authentification is carried out on the basis of an authentication carried out by the second unit, and on the second unit side authentification is carried out on the basis of an authentication carried out by the ident medium. Also, on the first unit side, authentification is carried out on the basis of an authentication carried out by the ident medium via the second unit. Furthermore, an authentication could also be carried out on the ident medium side, in particular on the basis of an authentication carried out by a user by interaction with the ident medium, e.g. by entering a PIN code or by entering a biometric feature by means of a biometry sensor. If on the ident medium side or the second unit side an identity or authorisation is determined, and preferably authentificated, in principle it is sufficient that only data which indicates that the identity or authorisation was positively established, and preferably authentificated, is passed on to the second unit or to the first unit, in which case the type of authorisation is also given if appropriate. This data, which is wirelessly obtained from the second unit or first unit, in this case represents identification data or authorisation data which is abstracted from a particular person or a particular ident medium, and which makes the determination of an abstract identity or authorisation possible, e.g. the identity as administrator or person with access authorisation, perhaps with authorisation with a specified range. Thus on the first unit side or second unit side, it is unnecessary to maintain a database giving person-related or ident-media-related identities and authorisations, but it is sufficient if the ident medium carries or can provide identification data, which so to speak proves, as key data, affiliation to an abstract identity or the existence of a specified authorisation. Thus in the case of such an implementation, authentifications carried out on the ident medium side or/and second unit side or/and first unit side can be directed above all to preventing misuse, and in particular checking whether the user of the ident medium is the “true” user, or that the ident medium which interacts with the second unit is a “true” ident medium, or that the second unit which interacts with the first unit is a “true” second unit.

Against the background of these general explanations, it is specifically proposed that the determination device of the first unit is an authentification device, and designed to authentificate a notified identity or authorisation, and the notification device is an authentication device, and designed to prove the notified identity or authorisation by transmitting authentication data via the second and first wireless interfaces. As a further development, it is proposed that the notification device which acts as the authentication device is designed to receive the authentication data from the ident medium via the third wireless interface and the ident medium wireless interface or to read it out from it.

Preferably alternatively, but if desired also additionally, it can be provided that the determination device of the first unit is an authentification device, and designed to authentificate a notified identity or authorisation, and an authentication device of the ident medium is designed to prove, via the notification device, the notified identity or authorisation by transmitting authentification data via the third wireless interface and the ident medium wireless interface and via the second and first wireless interfaces. In this case too, all discussed approaches to authentification can be used. In contrast to the previously discussed version, according to the alternative further development proposal the ident medium has the authentication device, and the second unit can primarily fulfil only a relay function, to make communication between the first unit and the ident medium possible.

Alternatively or additionally to the implementation of the determination device of the first unit as an authentification device, it can be provided that the notification device is an authentification device, and designed, for positive determination of an identity or authorisation, to authentificate it, and an authentication device of the ident medium is designed to prove the identity or authorisation by transmitting authentication data via the third wireless interface and the ident medium wireless interface.

In the case of configuration of the ident medium with its own determination device, this can be an authentification device, which is designed, for positive determination of an identity or authorisation, to authentificate it, preferably on the basis of an interaction with the user, e.g. by input of a PIN code or of a biometric feature. In particular, the latter two versions come into consideration if the ident medium is an electronic device, e.g. a mobile telephone or a mobile computer.

Regarding the authentifications which can be carried out on the first unit side and second unit side, it is proposed as specially preferred that the authentification device of the first unit and the authentication device of the second unit or of the ident medium, or that the authentification device of the second unit and the authentication device of the ident medium, are designed to cooperate to execute a challenge-response authentification. The challenge-response authentification is an example of authentification on the basis of knowledge, but in this case the knowledge itself is not transmitted, to exclude the danger of disclosure of the knowledge. Instead, only evidence that the subject who is authenticating himself or herself undoubtedly possesses the knowledge is supplied.

It should be noted that within the inventive and further development proposals, various authentication or authentification methods can be used. However, as previously discussed, authentification or authentication by specific methods is not obligatory. Identity determination or authorisation determination can also take place on the basis of only the identification data which the ident medium carries, and which according to implementation possibilities which come into question is analysed either by the second unit or by the first unit for identity determination or authorisation determination. In the case of such implementations, the authentification would so to speak result from the supply of this data itself.

It can usefully be provided that the first range is noticeably greater than the second range, preferably by a factor of at least about 3 to 10. For example, the first range is thought of as being at least about 20 cm, preferably at least about 70 cm, highly preferably at least about 2.5 cm, and the second range is thought of as being a maximum of about 10 cm, preferably a maximum of about 5 cm. The ident medium wireless interface can therefore have a significantly shorter range than the first and second wireless interfaces of the first unit and second unit. Thus ident media which simply for reasons of distance cannot cooperate directly with the first unit can be used for identification to the first unit.

Additionally, by means of the second unit, adaptation between different data transmission standards or data transmission techniques can be achieved. Accordingly, it can be provided that the first and second wireless interfaces are implemented for data transmission according to a first transmission technique or/and according to a first transmission standard, and that the third wireless interface and ident medium wireless interface are designed for data transmission according to a second transmission technique which is different from the first, or/and according to a second transmission standard which is different from the first.

According to a preferred embodiment, one read unit, preferably an RFID or NFC read unit, is used according to the first aspect of the invention as the second unit, in which case the wireless interface of the read unit represents the third wireless interface, which is provided for coupling to at least one transponder, preferably an RFID or NFC transponder, which acts as an ident medium, and a further read unit wireless interface associated with the first unit represents the second wireless interface.

Above all, the idea is that the first unit has at least one actuator, or a separate actuator device with at least one actuator is associated with the first unit, the first unit being designed to actuate or trigger the actuator depending on successful identification.

In a further development, it is proposed that the first unit is a locking unit, which depending on successful identification by means of the actuator enables physical access, e.g. triggers or unblocks the opening of a door. Specially preferably, it is provided that the first unit is integrated into an electronic lock cylinder. A useful possibility is the integration of the first unit into a lock cylinder handle, which in the case of a door projects from a door leaf on one side of it. In this case, it can be provided that with the door closed, the second unit is arranged on the other side of the door opposite the handle which has the first unit, thus for example enabling ident media with a very short range, e.g. passive RFID cards with a transmission width of only 3 to 5 cm, to interact with the first unit via the second unit. Alternatively or additionally, the or a second unit can be provided on the same side of the door as the handle which has the first unit. Usually, a second unit will be provided on both sides of the door, but this is not obligatory.

The ident medium or transponder can be implemented as a data or chip card, e.g. a so-called smart card. Another possibility is that the ident medium or transponder is integrated into an electronic device, e.g. a mobile telephone or hand-held computer.

The invention in its various aspects is explained in more detail below, on the basis of embodiments shown in the figures.

### BRIEF DESCRIPTION OF THE DRAWINGS

FIG. 1 shows schematically a locking system which implements the various aspects of the invention as a example, with a portable ident medium, a locking unit and a mediation unit which mediates between the ident medium and the locking unit, each shown schematically in the form of block diagrams.

FIG. 2 shows a schematic block diagram of the mediation unit.

FIG. 3 shows a possible implementation of a wireless interface device with associated components of the mediation unit, according to a first variant embodiment.

FIG. 4 shows a possible implementation of a wireless interface device with associated components of the mediation unit, according to a second variant embodiment.

### DESCRIPTION OF THE INVENTION

According to a first aspect, the invention provides a read unit—with a wireless interface for generating an electrical or magnetic or electromagnetic alternating field—which can be switched automatically between different operating states including an idle operating state which results in lower energy consumption. According to the first aspect, the inventive and further development proposals can be applied irrespective of a specific application situation on RFID or NFC read units and RFID or NFC transponders working with them, e.g. on read units and transponders according to the ISO 14443A/Mifare or FeliCa standard and other relevant standards. In particular, read units and transponders which interact with each other via a near field coupling, e.g. on the basis of a 125 kHz or 13.56 MHz alternating field, are thought about. Specially relevant is an inductive near field coupling, which in the case of a passive transponder is used for energy supply to the transponder from the alternating field, between a read unit and a transponder.

According to a second aspect, the invention relates to a monitoring device and a monitoring method for monitoring a surrounding region by means of an electrical or magnetic or electromagnetic sensor alternating field. The monitoring device and monitoring method are based on at least one sensor variable which depends on an electrical or magnetic or electromagnetic property of the surrounding region, or/and on a reaction from the surrounding region, being captured, to be able to respond to changes of an electrical or magnetic property of a surrounding region. As the sensor variable, an instantaneous oscillation frequency of an oscillator which is used to generate the alternating field comes specially advantageously into consideration, directly or indirectly. According to the second aspect, the inventive and further development proposals can be used effectively in the context of the invention according to the first aspect, but are also universally applicable in other contexts. The following explanation in the context of a locking system and an RFID or LFC read unit therefore presents only one of various possibilities for use, purely as an example.

According to a third aspect, the invention provides a method for controlling a system on reception of a wireless data transmission between a first component and a second portable component. The method according to the third aspect can be used specially effectively in association with a read unit according to the first aspect, and can also use a monitoring device or a monitoring method according to the second aspect very effectively. However, quite different application situations are conceivable.

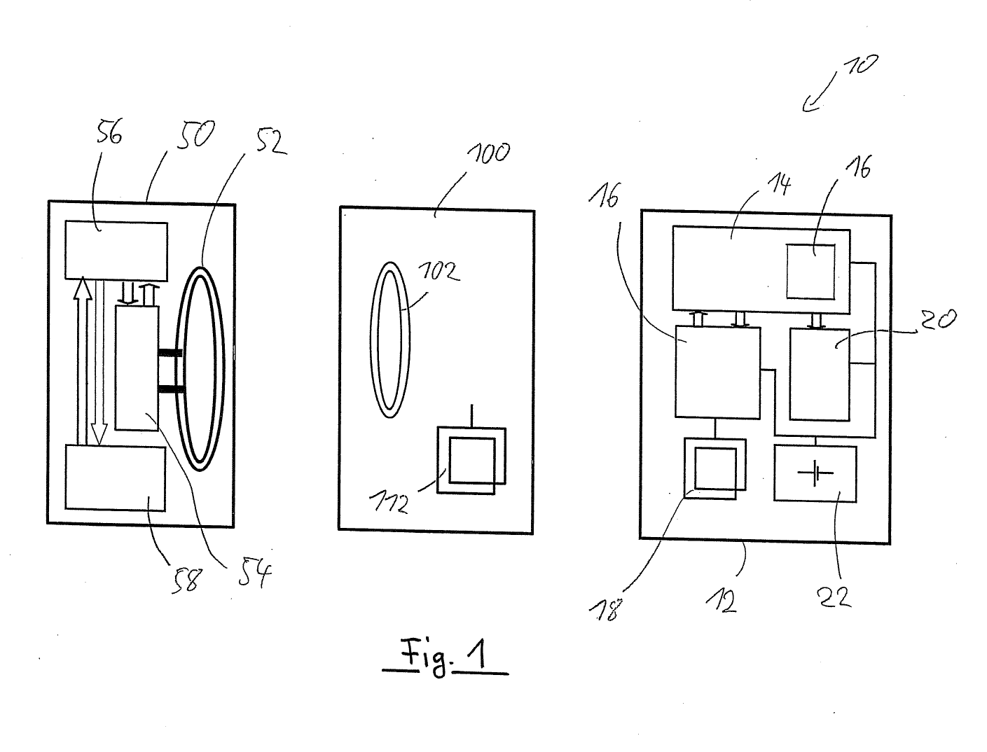

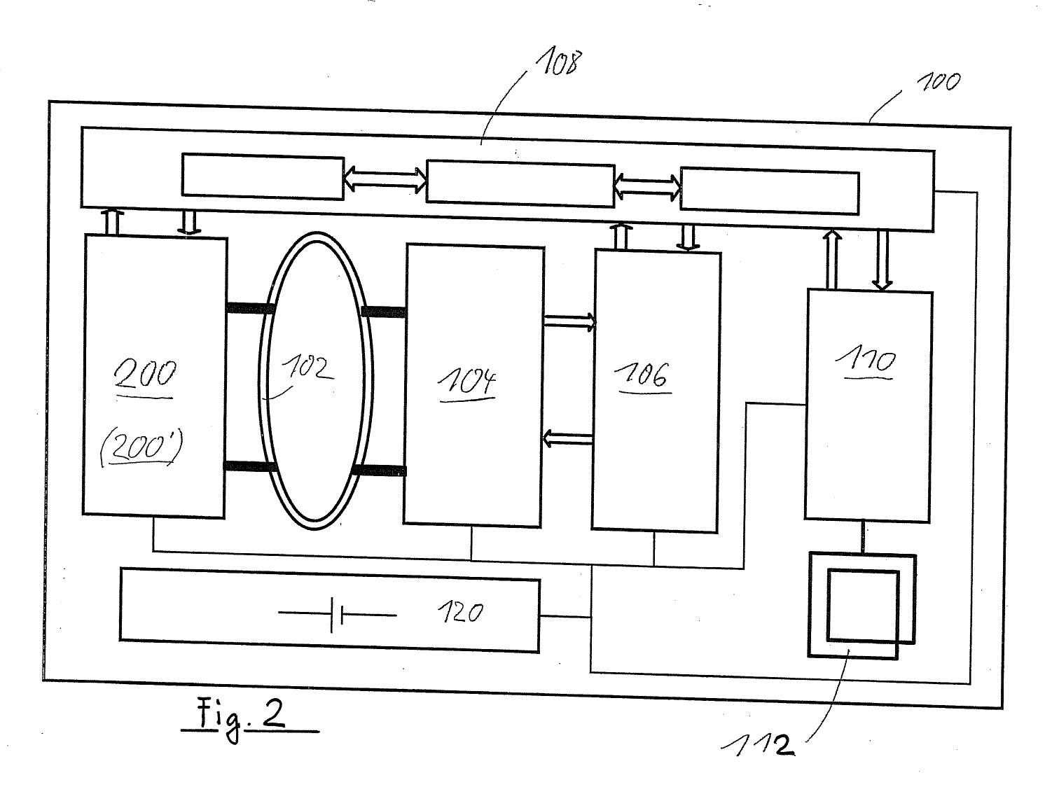

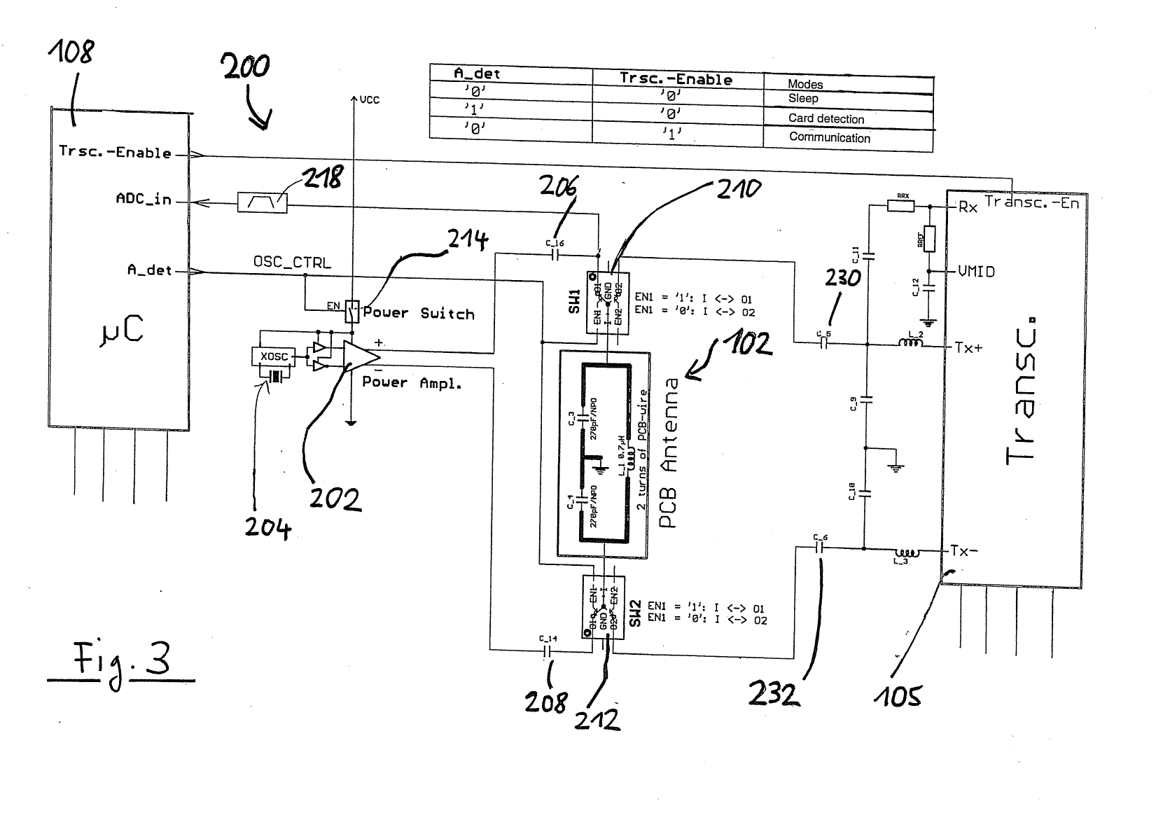

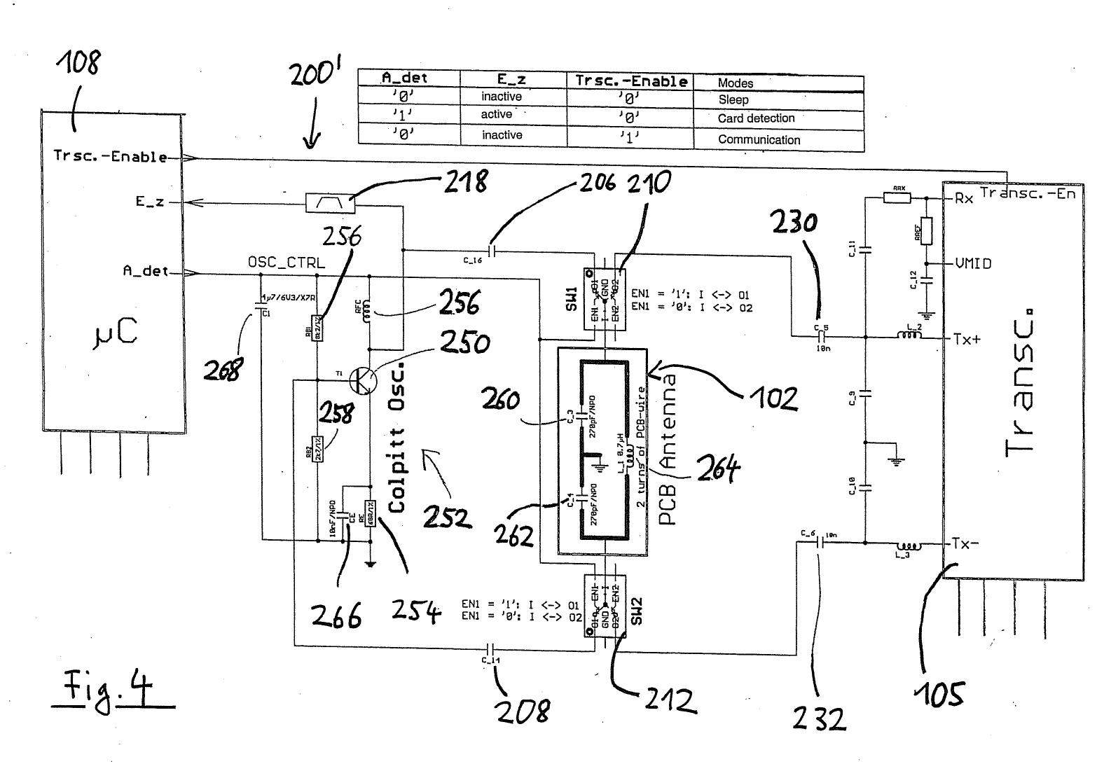

According to a fourth aspect, the invention provides a system for identity determination or/and authorisation determination, if appropriate for enabling or preventing a logical or/and physical access to a destination device. FIGS. 1 and 2 show schematically an example of a specific instance of this system as a locking system, which with the variant embodiments shown in FIGS. 3 and 4 as examples also implements the invention according to the first, second and third aspects. However, the inventive and further development proposals according to the fourth aspect can also be implemented independently of the inventive and further development proposals according to the first, second and third aspects of the invention.

FIG. 1 shows a locking system 10 with a locking unit 12, which can usefully be integrated into a so-called digital or electronic lock cylinder. A processor 14 with an internal RAM or/and ROM area 16 is connected bidirectionally to a transmission and reception electronic unit 16, to which an aerial arrangement 18 is connected. The transmission and reception electronic unit 16, in combination with the aerial 18, forms a wireless interface for wireless communication, e.g. by means of an alternating magnetic field, e.g. in the myriametric wave, long wave or medium wave frequency range. The alternating magnetic field preferably has a range of about up to 1.5 m, and specially preferably of about 5 m or more. The wireless interface 16, 18 is provided to carry out data communication with the wireless interface of an ident medium which is associated with the locking unit 12, e.g. a portable ident medium corresponding to DE 103 41 370 A1 or a stationary ident medium corresponding to DE 20 2006 859 U1. Preferably, the processor 14 has an authentification function, implemented in software and/or hardware, so that it can verify and identify the ident medium as authorised, in cooperation with an authentication function of a corresponding processor of the ident medium. Usefully, a challenge-response authentification by means of a corresponding challenge-response communication between the processor 14 of the locking unit and the processor of the ident medium can be carried out via the wireless interface. The authentication of the ident medium to the locking unit can itself be based on authentification on the ident medium side. For example, the ident medium can be implemented so that a user must prove his or her authorisation by entering a PIN code or a biometric feature, e.g. a fingerprint, by means of a biometry sensor, optionally a fingerprint sensor, of the ident medium, before the ident medium identifies itself, or the user who is using the ident medium, to the locking unit, as authorised, via the wireless interface, e.g. through the discussed challenge-response communication. Such locking units and such ident media are prior art, and reference is made to various transponders, PIN code keypads, digital lock cylinders and other products of the applicant.

In the case of a digital lock cylinder, the locking unit 12 which is integrated in it has an actuator 20, which in the case of identification of an ident medium or its user as authorised can be triggered by the processor 14 to unblock a locking mechanism, so that for example the user can now unlock and open a door by actuating a handle of the lock cylinder. For example, the actuator can be implemented as a magnet or lifting magnet or motor. However, in other contexts other actuators are conceivable, e.g. a circuit, a processor and a software program. Mechanical unblocking is therefore not obligatory. The various components of the locking unit are supplied with electrical energy by a battery energy supply 22. However, depending on the application situation, energy supply from the mains also comes into consideration.

Also in the context of a locking system according to the invention, it is thought that the locking unit 12 can cooperate with ident media, in particular transponders, as discussed. However, according to the invention it is provided that that other types of ident media, which cannot communicate directly via the wireless interface 16, 18 with the processor 14 of the locking unit, either because a different data transmission technique or a different data transmission protocol is implemented for such other kinds of ident media, or because a range of a wireless interface of such a different kind of ident medium is insufficient to make data communication directly between the locking unit and the ident medium possible, are equipped with a key function in relation to the locking unit 12. In this respect, ident media with very short range wireless interfaces based on near fields, and with a range which may possibly be only a few centimetres, are thought about. In the case of a digital lock cylinder, the range could be too short to reach from the ident medium which is held or carried by a user on one side of the door to the locking unit which may possibly be integrated in a handle of the lock cylinder on the other side of the door, so that in this respect it would achieve nothing to equip the locking unit with a wireless interface which suits the wireless interface of the ident medium.

An example of a corresponding ident medium is a passive RFID transponder, e.g. in card form, e.g. according to the ISO 14444A/Mifare or FeliCa standard, the wireless interface of which is designed for inductive near field interaction at 13.56 MHz, the electrical energy which supplies the components of the transponder being taken from an inductive near alternating field generated by an associated read unit. A corresponding transponder is designated by 50 in FIG. 1, and has an aerial arrangement 52 and a transmission and reception electronic unit 54. The transmission and reception electronic unit 54, on the one hand, makes available to the other components of the transponder the rectified electrical energy taken from the alternating field, and on the other hand is connected bidirectionally to a processor 56, which can at least read data from a memory area 58 and may optionally also be able to write data into the memory area 58. For the specific application on which the locking system of FIG. 1 is based, key data, which can also be called identification data, is received or can be written into the memory area 58, to prove access authorisation wirelessly to the locking unit with the mediation of a mediation unit 100 implemented as an RFID read unit. The ident medium 50 can also be equipped with a biometry sensor or a PIN code input option, to give higher security against misuse.

The read unit 100, or the mediation unit 100 which fulfils a read function, has a wireless interface 102, 104 and 106 which is complementary to the wireless interface 52, 54, where 102 designates an aerial arrangement, 104 an analogue circuit arrangement which drives the aerial 102, and 106 a transceiver circuit which is bidirectionally connected to the analogue circuit arrangement, e.g. a Universal Asynchronous Receiver Transmitter (UART). In the transmission and reception electronic unit 54 of the transponder 50, the functions of a complementary analogue circuit and a complementary transceiver circuit are integrated.

The analogue circuit 104 is implemented to generate a quartz-stabilised electrical alternating field which drives the aerial arrangement 102. For example, data can be transmitted to the transponder 50 by load modulation. The transmission or reception electronic unit 54 of the transponder can also transmit data in the direction of the read unit, for example also by load modulation.

The transceiver 106 receives data to be transmitted to the transponder from a processor 108, and feeds data received from the transponder 50 to the processor 108. The processor 108 can have various integrated components, which could easily be arranged separately from the processor, e.g. memory areas, interrupt timers, counters and ND converters or similar, as indicated in FIG. 2 by bidirectionally connected blocks in the block which represents the processor 108.

A transmission and reception electronic unit 110, to which an aerial arrangement 112 is connected, is connected to the processor 108 for the mediation function of the mediation unit 100. The transmission and reception electronic unit 110 and the aerial arrangement 112 form a wireless interface which is complementary to the wireless interface 20, 22 of the locking unit 12. By means of the wireless interface 102, 104, 106 of the mediation unit 100 and the wireless interface 52, 54 of the ident medium 50, ident data which is read out of these or transmitted to the mediation unit, in particular ident data from the memory area 58 of the ident medium 50, is transmitted by the processor 108, in the received form or further processed, via the wireless interface 110, 112 to the locking unit 12, which receives this data via the wireless interface 16, 18 and analyses it by means of the processor 18. Another possibility is that the processor 108 of the mediation unit 100 analyses the ident data received from the ident medium 50, and then, in the case of a positive determination of an identity or authorisation, transmits ident data abstracted from the ident data received from the ident medium 50 via the wireless interface 110, 112 to the locking unit 12, which receives this data via the wireless interface 16, 18 and analyses it by means of the processor 14. Thus, for example, so to speak only the information that an access authorisation exists could be given to the locking unit. There are many possibilities here for detailed implementation. In the simplest case, it is sufficient to transmit a specified identification data set from the ident medium 50 via the mediation unit 100 to the locking unit 12, so that the processor 14 drives the actuator 20 to release an access or to unblock a closure. Preferably, however, the processor 14 of the locking unit 12 carries out an authentification, e.g. on the basis of a challenge-response data dialogue, in which case it is thought above all that either the processor 108 of the mediation unit 100 or the processor 56 of the ident medium 50 carries out the corresponding authentication. In the latter case, the mediation unit 100 would actually be used only as a device to mediate the data transmission between the ident medium 50 and the locking unit 12. Additionally or alternatively, authentification on the mediation unit 100 side, carried out by its processor 108 in association with authentication carried out by the processor 56 of the ident medium 50, is also conceivable. In this way or that, the ident medium 50, in combination with the mediation unit 100, from a functional point of view fulfils essentially the functions which a traditional transponder, directly related to the locking unit, and having a wireless interface which is complementary to the wireless interface 16, 18, fulfils.

Preferably, the mediation unit 100 is equipped with an energy supply 120 based on a non-rechargeable or rechargeable battery, preferably a non-rechargeable battery, with a battery arrangement of very large capacity, so that a corresponding mediation unit or multiple corresponding mediation units can be placed near a locking unit 10 or a locking unit 10 in each case, without great installation cost, and without the need for the presence of a mains connection or for laying energy supply cables. However, the result is the following problem, which in itself is against the implementation of the mediation unit with a battery energy supply: traditional RFID-based read units (in particular card readers) build up a permanent electrical or magnetic or electromagnetic near field (often 125 kHz or 13.56 MHz), so that RFID cards or passive transponders which are brought into this near field can be powered from this field, so that they can build up communication with the read unit by means of the thus acquired electrical energy, e.g. to exchange ident data. However, to obtain such a near field permanently, a relatively large amount of energy is required, which in practice makes an external energy supply with correspondingly increased installation cost obligatory. In contrast, according to the invention, with the mediation unit 100 a significantly reduced power consumption averaged over time is achieved, by the mediation unit automatically switching between different operating states, including an idle operating state, in which the electrical energy consumption of the monitoring unit is significantly reduced. In the idle operating state, all components of the monitoring unit 100 are deactivated, with the exception of a function which enables the monitoring unit to switch automatically from the idle operating state into at least one other operating state, e.g. on the basis of an interrupt or a counter state of an internal counter of the processor 108.

It is understood that in the idle operating state, the wireless interface 110, 112 which is associated with the locking unit 12 is ideally switched off, and accordingly consumes no electrical energy. It is possible to provide that in such an operating state of the mediation unit, the wireless interface 110, 112 is switched on only when the mediation unit 100 is connected via the wireless interfaces 102, 104, 106 and 52, 54 to an ident medium 50, and ident data or authentification data or authorisation data is to be transmitted to the locking unit 12. Of course there can be other operating states in which data communication between the mediation unit 100 and the locking unit 12 is made possible, i.e. the wireless interface 11, 112 is switched on.

Below, the wireless interface 110, 112 and the locking unit 12 are not further discussed, since what matters here is the energy-saving version of the read unit 100 or mediation unit 100 which makes operation on the basis of battery energy possible according to the first aspect of the invention, and monitoring an environment of the monitoring unit, which comes into question in this context, according to the second aspect of the invention, and control of a system for receiving a wireless data transmission between a first and a second component according to the third aspect of the invention, on the basis of the described embodiment or of variant embodiments thereof. The mediation unit 100 should be seen in this respect as a read unit, which can also be used in completely different technical contexts, and then instead of the wireless interface 110, 112 can for example have components which implement other functions, depending on the application situation.

A first approach to reducing the sample consumption or power consumption of the read unit 100 is based on a polling method. According to this approach, the read unit 100 spends most time in a “sleep mode”, the idle operating state discussed above, in which only very little energy is consumed. The read unit wakes repeatedly at time intervals, e.g. periodically (e.g. once per second) out of “sleep mode”, to establish whether there is a transponder in the nearer environment, i.e. the near field region. For this purpose, the electrical or magnetic or electromagnetic alternating field is fully built up by means of the wireless interface 102, 104, 106, then to detect, via the wireless interface, the inductive or capacitive or electromagnetic coupling of the transponder, e.g. through a detectable attenuation (which can be perceived by the analogue circuit arrangement 104 as a load) of the field. If no transponder is detected in the near field region, the read unit 100 returns automatically to the idle operating state, and later (e.g. after 1 second) again automatically activates the wireless interface 102, 104, 106, and checks again whether a transponder is present in the near field region. According to this method of operating the read unit 100, the wireless interface 102, 104, 106 is repeatedly switched on and off at time intervals for polling. However, the described manner of conducting the polling has the disadvantage that the wireless interface 102, 104, 106 is also switched on with respect to components which are not required for pure card detection, e.g. through the detectable load of a coupled transponder, but are used for data communication with the coupled transponder. However, for detection of a coupled transponder through the energy loss of the alternating field, it is enough to generate such an alternating field in a defined way, and to detect the attenuation of the field or the load caused by the transponder by coupling to the alternating field.

Correspondingly, in the case of a first variant embodiment, to be explained on the basis of FIG. 3 in association with FIG. 2, the read unit 100 is implemented with its own wireless interface which is only used for transponder detection, and which is formed of a monitoring device 200 together with the aerial arrangement 102. Without restricting generality, the aerial arrangement 102 can usefully belong to both the wireless interface 102, 104, 106 and the wireless interface 200, 102, and switches, which for a data communication operating state connect the aerial arrangement 102 of the analogue circuit 104, and for a monitoring operating state connect the aerial 102 of the monitoring device 200, can be provided. Instead of a switch arrangement, a different kind of insulation arrangement, e.g. based on diodes, in particular PIN diodes, can be implemented. Of course, the monitoring device 200 could also be equipped with its own aerial arrangement, and it is useful, but not obligatory, that the wireless interface 102, 104 and 106 on the one hand and the wireless interface 200, 102, or 200 with its own associated aerial arrangement, generate an alternating field, to which the appropriate transponder can couple and withdraw energy from the field, at the same frequency.

With the monitoring device 200, polling is possible in such a way that the wireless interface 102, 104, 106 which is used for data communication is not switched on to detect, through the coupling of a transponder in the near field region, its presence, but the wireless interface 200, 102 is switched on to detect, through the coupling of a transponder in the near field region, its presence. Consequently, the read unit 100 switches repeatedly at time intervals between the idle operating state, in which both wireless interfaces are switched off, and the monitoring operating state, in which the wireless interface 200, 102 is switched on, but the wireless interface 102, 104, 106 which is used for data communication is switched off. The processor 108 is implemented or programmed so that on detection of an energy loss indicating the presence of a transponder in the near field region, more precisely on a load which indicates such an energy loss and is seen by the monitoring device 200 via the connections of the aerial arrangement 102, it switches on the wireless interface 102, 104, 106 and makes standard data communication between the transponder 50 and the read unit 100 possible. Before beginning a data communication, e.g. for identification or authentification, an additional checking step can be provided, to check whether the alternating field energy loss on which the detected load or load increase is based is actually caused by a transponder 50 with which data communication can take place.

FIG. 3 shows a possible version of the aerial arrangement 102, in combination with the monitoring device 200 and a functional group 105, which essentially contains the analogue circuit 104 and the transceiver 106, for example is implemented as one component, and for example can be implemented on the basis of a Philips/NXP component PN531 or PN511. Advantageously, for example, a Philips/NXP module PN65K, which has an NFC controller PN531 in combination with a “Secure Smart Card” controller, could also be used, which for example can be useful for implementations of a mobile telephone as a transponder.

The monitoring device 200 has, as its central part, a power amplifier 202, which at its two inputs is driven by the output signal of a quartz oscillator 204, offset by 180° phase difference, and drives a PCB aerial, which is used as the aerial arrangement 102, with an electrical alternating field via coupling capacitors 206, 208 and switches 210, 212, to generate the alternating field to detect the transponder, i.e. a “monitoring alternating field”. The monitoring device 200 is switched on when the processor 108 outputs a level 1 at an output A_det, so that a power switch 214, which is driven by this control signal, is closed, so that the power amplifier 202 and the quartz oscillator 204 receive operating voltage. The control signal A_det is also fed to the switches 210, 212, to switch them into a switching state in which the aerial 102 is connected via the capacitors 206, 208 to the outputs of the power amplifier 202, and the electrical oscillation which the latter supplies is injected into the aerial 102. Via a level adapter 218, a voltage signal representing the amplitude of the electrical oscillation in the PCB aerial 102 is fed to an input ADC_in of the processor 108. On the basis of the defined excitation of the PCB aerial 102 by the driver circuit formed by the amplifier 202 and the oscillator 204, from this voltage signal, converted into a digital value by means of an A/D converter, an energy loss of the generated alternating field can be detected as the effective load. If this load exceeds a threshold value, this indicates the coupling of a transponder to the generated monitoring alternating field, so that now, by switching the output A_det to level 0 and switching an output Trsc.-Enable of the processor 108 to level 1, the transceiver 105 is connected, now to connect the wireless interface 104, 106 to the aerial arrangement 102. The result of outputting level 0 at output A_det is that the switches 210, 212 are switched into a second switching state, in which the PCB aerial 102 is connected via capacitors 230, 232, and other components corresponding to normal wiring of such a transceiver functional group, to terminals Rx, Tx+, Tx− and VMID of the transceiver 105. In the case of the modules PN511 and PN531 discussed above, the terminals Tx+ and Tx− are also called TX1 and TX2. The load-modulated 13.56 MHz oscillation signal, which feeds the PCB aerial 102 and generates the alternating field by means of it, is supplied to these terminals. The terminal Rx or RX receives the load-modulated 13.56 MHz oscillation signal from the aerial arrangement 102. At the terminal VMID, an internal reference voltage is output. Reference is made to corresponding product information about the discussed transceiver modules.

If the wireless interface 102, 104, 106 or 102, 105 is connected, the read unit 100 works exactly like traditional read units, in particular RFID-based card readers, which generate a permanent electromagnetic near field or alternating field.

According to the variant embodiment of FIG. 3 in combination with FIG. 2, for transponder detection the electromagnetic near field or alternating field is fully built up, and the transponder detection is based on coupling the transponder in such a way that it takes energy from the alternating field, which is detectable as a load increase. The monitoring state which is implemented in this way, using the wireless interface 200, 102, can therefore be identified, like the communication operating state (of the read unit 100 or mediation unit 100) which is used for data communication and uses the wireless interface 102, 104, 106, as a coupling operating state, in which the or a wireless interface is switched on, so that a transponder in the near field region can couple inductively or capacitively or electromagnetically to the latter. For transponder detection, after switching into the monitoring operating state, first the quartz oscillator is activated, and then its oscillation is amplified and applied to the PCB aerial. So that a coupling, in particular an inductive coupling, between the aerial arrangement 102 and a transponder in the near field region is possible, in particular the transponder can be supplied with energy from the electrical field, and correspondingly voltage reduction on the PCB aerial corresponding to the resulting load (eddy current) is detectable, a relatively strong alternating field must be generated. The oscillation generation by means of the quartz oscillator and amplification of this oscillation by means of the power amplifier 202 also consume a comparatively large amount of electrical energy.

On the basis of the implemented polling operation, the mean energy consumption E_{verbr} of the read unit 100, in a broad estimate, is essentially made up as follows:
a) A current consumption E_{det}, which is only important as a mean value over time and can therefore be taken as quasi-constant, and which results from the regular waking, including near field building for transponder detection (card detection if appropriate), can be assumed, and
b) an energy consumption Eₖₒₘ for communication with detected cards, so that

E_{verbr}=E_{det}+Eₖₒₘ

is to be calculated, or—expressed as current consumptions—

I_{verbr}=I_{det}+Iₖₒₘ

is to be calculated, where
I_{verbr} is the mean current consumption of the read unit (card reader if appropriate),
I_{det} is the mean consumed current for (regular) transponder detection, and
Iₖₒₘ is the mean consumed current for (occasional) communication with detected transponders.

For example, if it is assumed—without restricting generality—that a read unit communicates with 200 transponders every day, and the communication with each transponder lasts 50 ms, during which a mean current of 100 mA is drawn from an electrical energy supply, in particular a battery, the mean current consumption of the read unit for reading 200 transponders is approximately

Iₖₒₘ=200×100 mA×50 ms/day=11.6 μA (1 day<->86400 s)

Let it be further assumed that the read unit, when polling for card detection, “wakes up” once per second, meaning that first the quartz oscillator is activated, and then the resulting oscillation is amplified and applied to the aerial. In the case of this approach to transponder detection, a 13.56 MHz RFID or NFC card reader typically consumes 70 mA over a period of 2 ms. When a transponder approaches, in particular a transponder in the form of a normal card, a 5-10% voltage loss can be observed. The result, in the case of the approach to transponder detection based on coupling a transponder to the generated alternating field, is a mean current consumption of approximately

I_{det}=i_{det}×t_{det}=70 mA×2 ms/s=140 μA

The result in total is a mean current consumption I_{verbr} of approximately 151.6 μA.

If an effective charge of 1500 mAh of a typical lithium AA battery is assumed, the result is a battery lifetime T_{batt} of about 13 months:

T_{batt}=1500 mAh/211.6 μA=approx. 412 days

Compared with a non-polling RFID reader, this represents an improvement of about 2-3 orders of magnitude. However, changing batteries almost annually is still rather impracticable or even unacceptable for many applications, in particular if there are many corresponding RFID readers or NFC readers in an environment. On the other hand, for other applications changing batteries almost annually is quite acceptable, so that the variant embodiment according to FIG. 3 absolutely has its importance.

The estimate above shows that the current consumption of transponder detection is dominant, whereas occasional readout of a transponder or occasional data communication with a transponder has less importance. According to the estimate above, which is to be seen only as an example, about 92% of current consumption is assigned to transponder detection, although only one attempt at transponder detection is made per second. Further disadvantages of the described approach to polling with transponder detection via the coupling of a transponder to the generated alternating field are as follows:
A relatively high detection current I_{det} is required for a sufficiently strong alternating field, so that attenuation can be detected sufficiently reliably.
The settling time of the frequency-stabilised quartz is comparatively long, which contributes considerably to a very long total detection time t_{det}.

Correspondingly, compared with the monitoring device 200 of FIG. 3, a different way of monitoring the surrounding region of the read unit, not based on coupling a transponder to an alternating field with energy being drawn from the alternating field by the transponder, is preferable.

FIG. 4, in association with FIG. 2, shows a corresponding variant embodiment, in which instead of the monitoring device 200 a monitoring device 200′, the reference symbol of which is given in FIG. 2 in parentheses as an alternative to reference symbol 200, is implemented.

The transponder detection which is implemented in the variant embodiment according to FIG. 4 is not based on attenuation of an electrical oscillation which generates an alternating field by a transponder which is coupled to the alternating field, but on the detuning of the electrical oscillation which generates an alternating field because of an electrical or magnetic or electromagnetic change in the environment caused by a transponder being brought into the environment of the read unit, or because of an electrical or magnetic or electromagnetic reaction of the transponder which has been brought in. The electrical oscillation is generated by a freely oscillating, non quartz-stabilised oscillator, and via the near field which is generated by an aerial or in general a field generation arrangement, an interaction occurs with the environment or the transponder, so that the electrical or/and magnetic or/and electromagnetic properties of the transponder, and its materials and components, if appropriate specifically an electrical oscillating circuit which can be excited to oscillation or/and an inductor of the transponder, react on the oscillation and can thus cause a frequency change of the electrical oscillation.

Thus the inductance of a conductor loop depends on the relative permeability μᵣ of the space which is permeated by the magnetic flux of the magnetic alternating field. If a material of a different relative permeability is brought into the permeated space, the result, because of the change which occurs to the inductance of a conductor loop or of a coil or conductor loop arrangement, is the change of a resonance frequency and thus oscillation frequency of an oscillating circuit which contains the inductor as a frequency-influencing or frequency-determining component. Correspondingly, in such an oscillating circuit, a frequency-influencing or frequency-determining capacitance can be changed by changing electrical properties of the environment, which by changing the resonance frequency can cause a change of the oscillation frequency. The polarisability, which is typically described by the relative dielectrical constant ∈ᵣ, of a dielectrical which is permeated by the field is relevant here. Depending on the type of alternating field which is used for transponder detection (also called the sensor alternating field below), the permeability properties or/and the dielectrical properties of the environment and of a transponder to be brought into it, i.e. near the read unit or mediation unit, can be relevant.

In contrast, a specially effective mechanism for transponder detection is based on an interaction of an oscillating circuit of the transponder or of an inductor of the transponder, in particular of an inductor of an oscillating circuit of the transponder, with the freely oscillating oscillator, which generates the sensor alternating field by means of the aerial or field generation arrangement. Admittedly the presence or absence of such an oscillating circuit or such an inductor of a transponder in the surrounding region could also in general be understood as an electrical or magnetic or electromagnetic property of the environment or of the transponder which is brought into it. However, an interaction or reaction onto the oscillator or oscillating circuit of the monitoring device which carries out the transponder detection occurs, of the type of an interaction between coupled oscillators (oscillating circuits) or coupled inductors, and has a specially strong effect in relation to the electrical oscillation on which the sensor alternating field is based, and thus can be exploited effectively for transponder detection. In particular, such a specially high selectivity can also be achieved for the response of the monitoring device to a transponder being brought in.

On the basis of the discussed mechanisms, the presence of an RFID-based transponder in the near field of an aerial arrangement, which is excited by a freely oscillating oscillator, results in a significant frequency change of the oscillator. In particular, the frequency change is specially large and easy to detect if the oscillation frequency of the oscillator is approximately resonant to an oscillating circuit of the transponder, since then, in the oscillating circuit of the transponder, an electrical oscillation, which reacts on the oscillating circuit of the read unit and also influences the oscillation frequency of the freely oscillating oscillator, is excited.

According to this approach, which is specially preferred in the context of the implementation of the invention, the result is the following relevant advantages among others:
a) The long build-up times of a quartz do not occur, since a freely oscillating, therefore not quartz-stabilised oscillator is used. For example, a Colpitts oscillator, which requires only a negligibly short settling time, resulting in a very small detection time t_{det}, can be used.
b) It is possible to work with considerably lower powers or field strengths of the alternating field to be radiated away, since even in weak fields, in the case of the presence of a transponder, significant detuning of the oscillation frequency occurs. The result is a significantly reduced detection current i_{det}.
c) The overall result of the greatly reduced detection time t_{det} and significantly reduced detection current i_{det} is a very great reduction of the energy requirement E_{det} or current requirement I_{det} for transponder detection.
d) Frequency detunings, that is frequency differences, can be captured considerably more reliably and at significantly less cost than load changes, for example by using simple digital counters.

According to the approach on which the variant embodiment of FIG. 4 is based, an oscillator circuit containing the aerial arrangement 102 as the frequency-determining or frequency-influencing element is used, e.g. a capacitive or inductive three-point circuit. Specially effective in the context considered here is a capacitive three-point circuit, which in the case of the monitoring device 200′ of FIG. 4 is implemented as a so-called Colpitts oscillator. This is a capacitively back-coupled three-point LC oscillator with a parallel oscillating circuit, which in the case of FIG. 4 is implemented as an emitter circuit. Such a circuit can be built with simple means, and works very reliably.

The transistor 250, which is suitable for an oscillation frequency range near, for example, 13.56 MHz, receives, at its input formed by the collector and the base, the oscillation feedback signal from the PCB aerial 102, if the switches 210 and 212, because of a level 1 of the output A_det of the processor 108, are in the switching position which connects the PCB aerial of the monitoring device 200′. The level signal 1 of the output A_det is dimensioned regarding voltage and the current which can be drawn from a driver circuit of the processor 108 so that it is sufficient as supply voltage for the Colpitts oscillator 252, which receives the supply voltage via a choke 256 at the collector, referred to the earth which is put on the emitter via a resistor 254, to stabilise the transistor working point. The working point is determined via a voltage divider with resistors 256, 258, which determine the working point bias which is put on the base.

The emitter circuit generates a phase rotation of 180°. To feed the feedback signal in phase to the input and achieve an automatically starting and automatically self-maintaining oscillation, an additional phase rotation also of 180° is required. This is achieved by the capacitive three-point consisting of two capacitors 260, 262 and one inductor 264 of the PCB aerial 102. A tapping point between the two capacitors is connected to earth, so that a connection to the emitter is produced via the common earth.

The inductor 264, together with the series circuit of the capacitors 260, 262, forms a parallel oscillating circuit, which represents the frequency-determining oscillating circuit of the Colpitts oscillator 252. The ratio of the capacitors 260, 262 determines a coupling factor. The capacitors 206, 208 discussed above separate the oscillating circuit galvanically from the transistor. The capacitor 266, which is connected in parallel to the stabilisation resistor 254, cancels the negative feedback for the oscillator signal, since for the electrical oscillation it bridges the resistor 254 by its small capacitive resistance. The capacitor 268 creates a capacitive connection of the operating voltage to the common earth potential, which is useful for perfect functioning of the oscillator circuit.

If the monitoring device 200′ is activated in the monitoring operating state of the read unit 100 (or mediation unit 100), the Colpitts oscillator 252 oscillates. The electrical oscillation, through the PCB aerial 102, generates an alternating near field, also called sensor alternating field, which extends into a surrounding region (near field region), retroacts via the electrical or magnetic or electromagnetic properties of the surrounding region onto the Colpitts oscillator, and influences its oscillation frequency. The instantaneous oscillation frequency is captured by feeding a voltage signal representing the electrical oscillation via a level adapter 218 to a counter input E_z of the processor 108. The counter of the processor 108 and the processor functions which analyse the counter levels should be seen from a functional point of view as belonging to the monitoring device 200′.

A previously discussed mechanism for monitoring the surrounding region for a transponder being present or brought in is based on the materials and components of the transponder, through its electrical and magnetic and electromagnetic properties, which can be described in particular by the relative permeability constant or relative dielectrical constant, influencing the electrical or magnetic or electromagnetic properties of the surrounding region which are “seen” as a whole by the generated alternating field, and through a change in particular of the effective inductance of the oscillating circuit, influencing its resonance frequency, and shifting it in the surrounding region relative to a state without a transponder.

Another previously discussed mechanism, but one which if considered fundamentally should also be derivable at least partly from such effective changes of the magnetic or electrical or electromagnetic properties, is the interaction of the oscillating circuit which forms the aerial 102 with a corresponding oscillating circuit of a relevant transponder. If the resonance frequency of the oscillator 252 is approximately resonant to the oscillating circuit of the transponder (an RFID card if appropriate), a significant frequency change of the oscillation frequency of the oscillator of the monitoring device 200′ occurs, and can easily be detected.

In this context, it should also be noted that the resonance frequency of the oscillating circuit of the transponder depends on the electrical (in particular dielectrical) and magnetic properties of the materials of the transponder itself, so that in this respect, by means of the interaction between the oscillating circuit of the transponder and the oscillating circuit of the monitoring device 200′, bringing a transponder into the surrounding region results in a change, which affects the monitoring device 200′, of the electrical or magnetic or electromagnetic properties of the surrounding region.

A frequency shift of the freely oscillating oscillator 252 of the monitoring device 200′ is preferably analysed on the basis of at least one monitoring condition and at least one reference oscillation frequency or/and at least one threshold frequency difference, to decide whether or not the detected frequency shift indicates the presence of a transponder in the surrounding region. As well as the magnitude of the frequency shift (frequency difference compared with a previous state), the direction of the frequency shift, to higher or lower frequencies, is relevant. Corresponding reference and threshold values and corresponding monitoring conditions can be determined empirically using an appropriate transponder, in particular can be taught after placing the read unit at a specified location, since the rest of the environment, in particular the materials of components and mountings of the read unit, has a role, as does the prevailing temperature at the location. Advantageously, the monitoring device can be calibrated automatically in a calibration mode of the read unit. Calibrations which automatically occur repeatedly can also be provided. The reference value can advantageously be a past value, e.g. a mean value of a defined earlier period, perhaps—to be able to take account of temperature changes which occur—a mean value of the last five minutes, to give an example.

If a frequency shift of the freely oscillating oscillator 152 of the monitoring device of the monitoring device 200′ is detected, and indicates the presence of a transponder in the surrounding region, the processor 108 then activates the wireless interface 102, 105 or 102, 104, 106, i.e. switches into a coupling operating state of the read unit 100, in which data communication between the transponder and the read unit can take place, if appropriate after a preceding check by means of the wireless interface 102, 105 or 102, 104, 106 for whether a transponder with which communication is possible is present in the near field region at all. Such a check could be done by detecting attenuation of the alternating field, or by a signal being sent to the transponder, in particular by load modulation of the alternating field, to report itself as ready for communication. A transponder could also be implemented or programmed so that after detection of an alternating field or—in the case of a passive transponder—after current begins to be fed to the transponder from the alternating field, it sends a signal (in particular by load modulation of the alternating field) which indicates its presence.

Preferably, polling by means of the monitoring device 200′ is implemented, in which case the microprocessor 108 switches the oscillator on and off through its control and supply signal which is output from the output A_det, and at its input E_z counts the frequency of the fed-back voltage signal while the oscillator is active. The switches 210, 212 switch the aerial either to the oscillator for transponder detection or to the transceiver 105, in particular RFID or NFC transceiver, for communication with the detected transponder, in which case the switches, according to the solution implemented in FIG. 4, can also be controlled by the signal from the output A_det. Instead of the switches, PIN diodes or HF analogue switches can be used.

In “sleep mode”, i.e. the idle operating state, preferably all components apart from a very low energy “watchdog/timer” are in a mode of vanishing or very low energy consumption. The “watchdog” can be an internal “watchdog” of the processor.

The “watchdog” wakes the processor (which can be a microcontroller) regularly for transponder detection. First the Colpitt oscillator 252 is activated, and for this purpose current is fed to it via A_det. After a few hundred nanoseconds, the processor can already begin to count the number of pulses at the input E_z for a predefined period, e.g. 200 μs, for frequency measurement. Then the oscillator can be switched off, and the current counter value can be compared with a reference value, to establish whether a transponder is nearby. In the case of successful detection of a transponder, by outputting the level 0 at the output A_det, the aerial 102 is switched to the transceiver 105, and simultaneously activated by means of a level 1 at the output Trsc.-Enable of the processor 108. After the data communication is carried out, the transceiver 105 is deactivated again, and the aerial is switched to the oscillator.

In an estimate, it can be assumed that the processor 108, the switches 210, 212 and the oscillator 252 draw a total current of about 15 mA during transponder detection. The resulting energy consumption, expressed as current consumption, is correspondingly approximately as follows:

I_{det}=15 mA×0.20 ms/s=3.00 μA

I_{ges}=3.00 μA+11.6 μA=14.60 μA

Compared with the transponder detection approach explained above, through the energy loss of an alternating field which is generated by a wireless interface to which the transponder couples, the current consumption for transponder detection is reduced by a factor of about 46, and in relation to the total current consumption, including the current consumption for reading according to the above assumptions, the result is a reduction by a factor of about 10. On the basis of such a current consumption, for the assumed lithium AA battery a lifetime T_{batt} of about 142 months or about 12 years is achieved.

A further advantage of the variant embodiment on which FIG. 4 is based is that depending on the dimensioning of the oscillator, very high sensitivity for transponder detection can be achieved. In practice, different frequency changes from a few % to 100%, i.e. the oscillator ceases to oscillate, can be observed with different dimensionings of the oscillator, if an RFID transponder, in particular a standard RFID Mifare card, approaches to a distance of about 4 cm from the read unit.

Compared with traditional, non-polling RFID readers, a reduction of current consumption by about 3-4 orders of magnitude is achieved, so that a corresponding read device, in particular an RFID or NFC reader, can be operated by a battery and used for a very long time without any problems and without any need to replace a battery.

It should be noted that because of the very energy-saving transponder detection, it can easily be provided that the monitoring device 200′ is activated more often than with the preceding assumptions, e.g. two or three times per second, to be able to respond reliably even to transponders which are brought very briefly into the surrounding region of the read unit, and to be able to start data communication with them.

It should also be noted that a monitoring device according to the invention, e.g. the monitoring circuit 200′ or alternatively the monitoring circuit 200, could be integrated directly into an RFID/NFC reader module, in particular a transceiver chip, without appreciably raising the costs for such a component.

Referring again to the locking system of FIGS. 1 and 2, it is thought that the mediation unit 100, in a programming operating mode, by means of the processor 108, via the wireless interface 110, 112 of the mediation unit 100 and the wireless interface 17, 18 of the locking unit 12, makes it possible to program the processor 14, or/and to enter locking, identification and authorisation data into the memory area 16 of the processor 14. For this purpose, the mediation unit 100 can be driven correspondingly via the wireless interface 102, 104, 106, e.g. by a transportable computer which has a complementary wireless interface. It is specially advantageous if the transceiver 106 is an NFC transceiver, which for such a programming mode can be switched into a client mode or peer-to-peer mode, to cooperate by means of a corresponding transceiver, which acts as master or also in peer-to-peer mode, of the portable computer.

With a read unit which is implemented as a mediation unit and implements the various inventive proposals, a locking system, as provided with the applicant's products listed above, can advantageously and without appreciable installation cost be made suitable for working with ident media in the form of passive NFC/RFID transponders, e.g. in card form, which do not communicate directly with the locking unit of, for example, a digital lock cylinder, and also cannot be supplied with energy by it. In parallel, active transponders and ident media can be used, corresponding to the discussed products of the applicant. The operating functionality regarding the use of the NFC/RFID transponder in relation to unblocking the locking unit of the locking system corresponds to the operating functionality of the transponder in relation to conventional NFC/RFID read devices. The transponder only has to be held in the near region of the read unit, whereupon, in the case of a positive determination of the identity or authorisation following the cooperation with the locking unit via the mediation unit, the locking unit enables access through the door by unlocking correspondingly or by enabling unlocking. In this context, it can be provided that for a defined period from positive identity determination or authorisation determination, an unlocked state or state of enabled unlocking is taken, the period corresponding to the time which a user needs, after bringing the transponder near the mediation unit, actually to open the door.

On the basis of the inventive and further development proposals, in particular an extension of an existing locking system to use passive RFID/NFC ident media is possible, since battery-operated mediation units can be used, and without any electrical installation cost can be positioned in association with an appropriate locking unit, on one or both sides of a door depending on the application situation, or similar.

Among other things, a method and a system for controlling a system on receiving a wireless data transmission between at least two components (12, 100, 50), wherein at least one wireless interface (102, 104, 106; 102, 105; 110, 112) for wireless data transmission can be or is activated, are proposed. According to the invention, a first component (100) monitors a surrounding region for the occurrence of at least one predefined change, or/and for the occurrence of at least one predefined reaction from the surrounding region. When such a change or reaction occurs, a wireless interface (102, 104, 106; 102, 105) is activated for wireless data transmission and if appropriate for energy supply to a second component (50) via the wireless interface. The predefined change or reaction is caused, in particular, by the second component (50) being brought into the surrounding region. The system can be a system (10) for identity determination or/and authorisation determination, e.g. a locking system. The first component (100) can mediate cooperation between the second component (50) and a further component (12) which is associated with a destination device, for example.

1. Read unit (100), e.g. RFID or NFC read unit (100), comprising:
at least one wireless interface (102, 104, 106; 102, 105), which is designed to generate, in at least one coupling operating state of the read unit, at least one of an electrical alternating field and a magnetic alternating field and an electromagnetic radiation alternating field, to be able to couple inductively or/and capacitively or/and electromagnetically to a transponder (50), if appropriate an RFID or NFC transponder (50), in an assignment region;
a controller (108), which is designed or programmed to respond in the coupling operating state, by means of the wireless interface, to a coupled transponder (50), to carry out a data communication comprising at least one of reading out at least one data value from the transponder and receiving at least one data value sent by the transponder and sending at least one data value to the transponder, or/and at least in the sense of detecting the presence of the coupled transponder; and
an electrical energy supply (120), which supplies the controller and the wireless interface with electrical operating energy;
characterised in that
in at least one idle operating state of the read unit (100), at least the wireless interface (102, 104, 106; 102, 105) is switched off, so that the electrical energy consumption of the wireless interface is at least reduced; and
in the coupling operating state of the read unit (100), the wireless interface (102, 104, 106; 102, 105) is switched on, so that a transponder (50) in the assignment region can couple inductively or capacitively or electromagnetically to it; and that the controller (108) is designed or programmed to switch automatically between multiple operating states, including the idle operating state and the coupling operating state.

2. Read unit according to claim 1, characterised in that the controller (108) is designed or programmed to switch automatically from the idle operating state directly into the coupling operating state, or from the idle operating state via a separate monitoring operating state of the read unit (100) into the coupling operating state, or/and that the controller (108) is designed or programmed to switch automatically from the coupling operating state into the idle operating state.

3. Read unit according to claim 2, characterised in that the controller (108) is designed to switch repeatedly at time intervals from the idle operating state into the coupling operating state or a special monitoring-coupling operating state of the read unit (100), to check by means of the or a wireless interface (200, 102; 102, 202, 204) whether a transponder (50) is present in the assignment region.

4. Read unit according to claim 3, characterised in that a monitoring device (200), which is associated with or belongs to the controller (108), and if desired provides its own monitoring wireless interface (102, 202, 204), is designed to respond in the monitoring-coupling operating state to an energy loss of the alternating field or of a monitoring alternating field generated by the monitoring wireless interface through the coupled transponder (50), to establish the presence of a transponder in the assignment region or in a surrounding region into which the monitoring alternating field extends.

5. Read unit according to claim 1, characterised by a monitoring device (200′) which is preferably independent of the wireless interface (102, 104, 106; 102, 105), is associated with or belongs to the controller (108), and is designed to respond to at least one change in a surrounding region of the read unit or at least one reaction from the surrounding region, the controller (108) being designed or programmed to react to a response of the monitoring device (200′) to the change or reaction by switching into the coupling operating state, to check by means of the wireless interface (102, 104, 106; 102, 105) or a wireless interface whether a transponder (50) is present in the assignment region, or/and to begin data communication by means of the wireless interface (102, 104, 106; 102, 105).

6. Read unit according to claim 5, characterised in that in the monitoring operating state of the read unit
a) the monitoring device (200′) is active, or can be activated repeatedly at time intervals, to be able to respond to the occurrence of at least one change in the surrounding region or the occurrence of at least one reaction from the surrounding region, and
b) the wireless interface (102, 104, 106; 102, 105) or at least one electrical component, which consumes electrical energy, of the wireless interface is switched off, so that the electrical energy consumption of the wireless interface is at least reduced;
the controller (108) being designed or programmed to switch automatically from the monitoring operating state into the coupling operating state when the monitoring device (200′) responds to a change in the surrounding region or to a reaction from the surrounding region.

7. Read unit according to claim 5, characterised in that the monitoring device (200′) is designed to respond to a change of at least one electrical or/and magnetic property or/and of at least one electromagnetic property of the surrounding region.

8. Read unit according to claim 5, characterised in that the monitoring device (200′) is designed to respond to an oscillating circuit in the surrounding region or/and to an inductor in the surrounding region, said oscillating circuit or inductor interacting on the basis of an electrical or/and magnetic alternating field or on the basis of an electromagnetic alternating field with an oscillating circuit (102) or/and an inductor (264) of the monitoring device.

9. Read unit according to claim 8, characterised in that the monitoring device (200′) is designed to generate at least one of an electrical sensor alternating field and magnetic sensor alternating field and electromagnetic sensor alternating field extending into the monitoring region, and to capture at least one sensor variable, which on the basis of the sensor alternating field depends on the electrical or magnetic or electromagnetic property of the surrounding region or/and on the basis of the sensor alternating field depends on an magnetic or/and electrical or/and electromagnetic reaction from the surrounding region.

10. Read unit according to claim 9, characterised in that the reaction is a reaction of the oscillating circuit or inductor in the surrounding region onto the oscillating circuit (102) or inductor (264) of the monitoring device (200′).

11. Read unit according to claim 9, characterised in that the monitoring device (200′) has an oscillator (252), which can be excited to a free electrical oscillation on which the generation of the sensor alternating field is based, in such a way that an instantaneous oscillation frequency depends on the electrical or magnetic or electromagnetic property of the surrounding region or on the reaction from the surrounding region, it being possible to capture the instantaneous oscillation frequency, or a capture variable which reflects it, or a subsequent variable which depends on the oscillation frequency or capture variable, as a sensor variable.

12. Read unit according to claim 11, characterised in that the monitoring device (200′) is designed or programmed to compare a captured sensor variable or captured sensor variables with at least one predetermined reference magnitude, or at least one reference magnitude which can be predetermined from at least one previously captured sensor variable, on the basis of at least one predetermined monitoring condition, and depending on the fulfillment or non-fulfillment of the monitoring condition to respond or not respond to a change in the surrounding region or reaction from the surrounding region.

13. Read unit according to claim 12, characterised in that the monitoring device (200′) has a counter which responds to the electrical oscillation, it being possible to capture instantaneous counter levels or subsequent variables determined from them or variables determined on the basis of reaching a trigger counter level as sensor variables.

14. Read unit according to claim 11, characterised in that at least one field generation arrangement, if appropriate an aerial arrangement (102), is provided, and is or can be associated with the monitoring device (200′) as monitoring field generation arrangement, if appropriate monitoring aerial arrangement, to generate the sensor alternating field.

15. Read unit according to claim 14, characterised in that the monitoring field generation arrangement (102) associated with the monitoring device (200′) is used as a frequency-determining or frequency-influencing part of the oscillator (252).

16. Read unit according to claim 15, characterised in that the oscillator includes an amplifier module (250), the output of which is or can be back-coupled via the monitoring field generation arrangement (102), as positive feedback, to an input of the amplifier module.

17. Read unit according to claim 16, characterised in that the amplifier module, together with the monitoring field generation arrangement, forms a capacitive or inductive three-point oscillator circuit, preferably a Collpits oscillator circuit (252).

18. Read unit according to claim 1, characterised in that the electrical energy supply (120) of the read unit (100) is a non-rechargeable or rechargeable battery energy supply.

19. Monitoring device (200′) for monitoring a surrounding region for changes, if appropriate said monitoring device being for a read unit (100) according to claim 1,
the monitoring device (200′) being designed to generate at least one of an electrical sensor alternating field and magnetic sensor alternating field and electromagnetic sensor alternating field extending into the monitoring region, and to capture at least one sensor variable which depends, on the basis of the sensor alternating field, on an electrical or/and magnetic property or/and an electromagnetic property of the surrounding region, or/and, on the basis of the sensor alternating field, on a reaction from the surrounding region, and to compare it, on the basis at least one predetermined monitoring condition, with at least one reference magnitude which is or can be predetermined,
the monitoring device having an oscillator (252), which can be excited to a free electrical oscillation on which the generation of the sensor alternating field is based, in such a way that an instantaneous oscillation frequency depends on the electrical or magnetic or electromagnetic property of the surrounding region or on the reaction from the surrounding region, it being possible to capture the instantaneous oscillation frequency or a capture variable which reflects it, or a subsequent variable which depends on the oscillation frequency or capture variable, as sensor variable.

20. Monitoring device according to claim 19, characterised in that it is designed to respond to an oscillating circuit in the surrounding region or/and an inductor in the surrounding region, said oscillating circuit or inductor interacting on the basis of the sensor alternating field with an oscillating circuit (102) belonging to the oscillator, or/and with an inductor (264) belonging to the oscillator, and thus reacting on the oscillation frequency.

21. Monitoring method for monitoring a surrounding region for changes, if appropriate as part of an operating method of a read unit (100) according to claim 1,
wherein at least one of an electrical sensor alternating field and magnetic sensor alternating field and electromagnetic sensor alternating field extending into the monitoring region is generated, and at least one sensor variable which depends, on the basis of the sensor alternating field, on an electrical or/and magnetic property or/and an electromagnetic property of the surrounding region, or/and, on the basis of the sensor alternating field, on a reaction from the surrounding region is captured, and compared, on the basis at least one predetermined monitoring condition, with at least one reference magnitude which is or can be predetermined,
and wherein an oscillator (252) is excited to a free electrical oscillation on which the generation of the sensor alternating field is based, in such a way that an instantaneous oscillation frequency depends on the electrical or magnetic or electromagnetic property of the surrounding region or on the reaction from the surrounding region, and the instantaneous oscillation frequency or a capture variable which reflects it, or a subsequent variable which depends on the oscillation frequency or capture variable, is captured as sensor variable.

22. Monitoring method according to claim 21, characterised by a response to an oscillating circuit in the surrounding region or/and an inductor in the surrounding region, said oscillating circuit or inductor interacting on the basis of the sensor alternating field with an oscillating circuit (102) belonging to the oscillator, or/and with an inductor (264) belonging to the oscillator, and thus reacting on the oscillation frequency.

23. Method for controlling a system on reception of a wireless data transmission between a first component (100), which may be a read unit (100), according to claim 1, and a second portable component (50), which may be a transponder, e.g. an RFID or NFC transponder (50), the method including activation of at least one wireless interface (102, 104, 106; 102, 105) for wireless data transmission;
characterised in that
the first component (100) monitors a surrounding region continuously or—preferably—repeatedly at time intervals for the occurrence of at least one predefined change or/and the occurrence of at least one predefined reaction from the surrounding region, and when such a change or reaction occurs, activates the wireless interface (102, 104, 106; 102, 105) for wireless data transmission and optionally for energy supply to the second component (50) via the wireless interface, the predefined change or reaction being caused by the second component (50) being brought into the surrounding region.

24. Method according to claim 23, characterised in that the first component (100) monitors the surrounding region for the occurrence of a change of at least one electrical or magnetic or electromagnetic property of the surrounding region.

25. Method according to claim 23, characterised in that the first component (100) responds to an oscillating circuit in the surrounding region or/and to an inductor in the surrounding region, said oscillating circuit or inductor interacting on the basis of an electrical or/and magnetic or on the basis of an electromagnetic alternating field with an oscillating circuit (102) or/and an inductor (264) of the first component.

26. Method according to claim 23, characterised in that the first component (100) monitors the surrounding region according to the monitoring method according to claim 21.

27. System (10) for identity determination or/and authorisation determination, and if appropriate for enabling or preventing a logical or/and physical access to a destination device, comprising:
a first unit (12), which may be associated with the destination device, and which has a determination device (14) which is designed to determine, on the basis of a preferably encrypted or/and bidirectional data exchange via a first wireless interface (16, 18) of the first unit with a second unit (100), an identity or/and an authorisation, the first wireless interface being designed for wireless data exchange over a first range;
at least one second unit (100) which is associated with the first unit (12), and has a notification device (108), which is designed to notify to the determination device (14) of the first unit (12) an identity or/and an authorisation, on the basis of existing identification data or/and authorisation data and of the data exchange which is carried out via the first wireless interface and a second wireless interface (110, 122) of the second unit over the first range;
characterised by
at least one portable ident medium (50), which carries at least identification data and has an ident medium wireless interface (52, 54), which is designed for wireless readout or transmission over a second range at least of the identification data or of identification data or/and authorisation data which is supplied on the basis of this identification data by a determination device (56) of the ident medium in the case of a positive determination of an identity or/and authorisation;
the notification device (108) of the second unit (100) also being designed to receive at least the identification data or/and authorisation data of the ident medium via a third wireless interface (102, 104, 106; 102, 105) of the second unit and the ident medium wireless interface (52, 54) over the second range, or to read it out from it, and to use this data or identification data or/and authorisation data which is supplied on the basis of this data by a determination function of the notification device (108) of the second unit (100) in the case of a positive determination of an identity or/and authorisation as existing identification data or authorisation data for notification of an identity or authorisation to the determination device (14) of the first unit (12).

28. System according to claim 27, characterised in that the determination device (14) of the first unit (12) is an authentification device, and designed to authentificate a notified identity or authorisation, and the notification device (108) is an authentication device, and designed to prove the notified identity or authorisation by transmitting authentication data via the second (110, 112) and first (16, 18) wireless interfaces.

29. System according to claim 28, characterised in that the notification device (108) which acts as the authentication device is designed to receive the authentication data from the ident medium (50) via the third wireless interface (102, 104, 106; 102, 105) and the ident medium wireless interface (52, 54) or to read it out from it.

30. System according to claim 27, characterised in that the determination device (14) of the first unit (12) is an authentification device, and designed to authentificate a notified identity or authorisation, and an authentication device (56) of the ident medium (50) is designed to prove, via the notification device (108), the notified identity or authorisation by transmitting authentication data via the third wireless interface (102, 104, 106; 102, 105) and the ident medium wireless interface (52, 54) and via the second (110, 112) and first (16, 18) wireless interfaces.

31. System according to claim 27, characterised in that the notification device (108) is an authentification device, and designed, for positive determination of an identity or authorisation, to authentificate it, and an authentication device (56) of the ident medium (50) is designed to prove the identity or authorisation by transmitting authentication data via the third wireless interface (102, 104, 106; 102, 105) and the ident medium wireless interface (52, 54).

32. System according to claim 27, characterised in that the determination device (56) of the ident medium (50) is an authentification device, which is designed, for positive determination of an identity or authorisation, to authentificate it, preferably on the basis of an interaction with a user.

33. System according to claim 28, characterised in that the authentification device (14) of the first unit (12) and the authentication device (108; 56) of the second unit (100) or of the ident medium (50), or that the authentification device (108) of the second unit (100) and the authentication device (56) of the ident medium (50), are designed to cooperate to execute a challenge-response authentification.

34. System according to claim 27, characterised in that the first range is noticeably greater than the second range, preferably by a factor of at least about 3 to 10.

35. System according to claim 34, characterised in that the first range is at least about 20 cm, preferably at least about 70 cm, highly preferably at least about 2.5 m, and the second range is thought of as being a maximum of about 10 cm, preferably a maximum of about 5 cm.

36. System according to claim 27, characterised in that one read unit (100), preferably an RFID or NFC read unit (100), according to any one of claims 1 to 18, is used as the second unit (100), in which case the wireless interface (102, 104, 106; 102, 105) of the read unit represents the third wireless interface, which is provided for coupling to at least one transponder (50), preferably an RFID or NFC transponder (50), which acts as an ident medium, and a further read unit (100) wireless interface (110, 112) associated with the first unit (12) represents the second wireless interface.

37. System according to claim 27, characterised in that the first unit (12) has at least one actuator (20), or a separate actuator device with at least one actuator is associated with the first unit, the first unit being designed to actuate or trigger the actuator depending on successful identification.

38. System according to claim 37, characterised in that the first unit (12) is a locking unit (12), which depending on successful identification by means of the actuator enables physical access, e.g. triggers or unblocks the opening of a door.
